(19) United States
(12) Patent Application Publication
(10) Pub. No.: US 2026/0276523 A1
(43) Pub. Date: Sep. 17, 2026

(54) DEVICE AND METHODS FOR HIGH-THROUGHPUT MICRO-NANO PARTICLE ANALYSIS

(71) Applicant: The Trustees of Columbia University in the City of New York, New York, NY (US)

(72) Inventors: Naixin QIAN, New York, NY (US); Wei MIN, New York, NY (US)

(21) Appl. No.: 19/664,427

(22) Filed: Apr. 30, 2026

Related U.S. Application Data
(63) Continuation of application No. PCT/US2024/054830, filed on Nov. 7, 2024.
(60) Provisional application No. 63/597,801, filed on Nov. 10, 2023.

(51) Int. Cl. G01N 15/1434; G01N 15/1429

(52) U.S. Cl. CPC G01N 15/1434; G01N 15/1429

(57) ABSTRACT

Systems, methods and devices for determining the identity of one or more nano-particles that share a defined set of spectral features above a detection limit, comprising obtaining SRS spectrum data from a multiphoton laser scanning microscope configured to perform hyperspectral stimulated Raman scattering microscopy; generating, by the machine learning module trained using a training set, the identity of one or more particles, based on the SRS spectrum data wherein the training set comprises real and/or synthetic data of SRS spectra, associated with respective particle identities and based on bulk standard spectra, estimated frequency uncertainty, and estimated instrumental noise wherein the machine learning module generates the particle identity based on respective spectral matching coefficients (SMCSRS) of the detected SRS spectrum data obtained and from the training set.

### CROSS-REFERENCE TO RELATED APPLICATIONS

This application is a continuation of PCT International Application No. PCT/US2024/054830, filed Nov. 7, 2024, which claims benefit of U.S. Provisional Application No. 63/597,801, filed Nov. 10, 2023, the contents of each of which are hereby incorporated by reference.

### BACKGROUND

The disclosures of all publications, patents, patent application publications and books referred to in this application are hereby incorporated by reference in their entirety into the subject application to more fully describe the art to which the subject invention pertains.

Micro-nano plastics originating from the prevalent usage of plastics have raised increasingly alarming concerns worldwide. However, there remains a fundamental knowledge gap on nanoplastics, because of the lack of effective analytical techniques.

Plastic pollution has been a rising global concern, with increasing plastic consumption every year1. Microplastic contaminations have been identified to prevalently from almost everywhere in the environments and even human biological samples[2-5]. Moreover, mounting discoveries suggest that the fragmentation of plastic polymer does not stop at the micron level but rather continues to form nanoplastics with expected quantities orders of magnitude higher[6]. With engineered plastic particles with fluorescent dyes or metal labels, researchers have shown the possibility of nanoplastics crossing the biological barrier and entering the biological systems [7-10], raising public concern on its potential toxicity[11].

Despite the urge to assess the concern, nanoplastics analysis remains challenging with traditional techniques. Unlike engineered nanoparticles prepared in laboratory as model systems, real nanoplastics in the environment are intrinsically label-free and have significant heterogeneity in both chemical composition and particle morphologies[12], which are likely to endure correspondingly different toxicity implications[13-16]. To address the existing knowledge gap on nanoplastics regarding their source, abundance, fate and potential toxicity encoded in such heterogeneous population, single-particle imaging with chemical specificity is undoubtedly essential to avoid informational loss from ensemble measurement. However, traditional single-particle chemical imaging techniques, namely FTIR or Raman microscopy, suffer from relatively poor instrumental resolution and detection sensitivity [17-19], which limit their success in revealing the heterogeneity only at microplastic level [20-22]. Particle imaging techniques with nano-sensitivity for plastic particles, such as electron microscopy and atomic force microscopy, lack the crucial chemical specificity to distinguish different compositions [23-25]. Extensive efforts have been made; however, most techniques are still bound by the fundamental trade-off between sensitivity and specificity, a recurring theme in analytical science [19, 26]. Very recently, single particle imaging with chemical spectroscopy started to be demonstrated by AFM-IR and STXM[27-30], but with extremely low throughput (>10 min/μm² with spectra for plastic identification), leaving it still insurmountable to quantify environmental micro-nano plastics with sufficient throughput and statistics. In summary, sensitivity, specificity, and throughput of single particle analysis are the three crucial requirements to analyze nanoplastics in real-life samples.

### BRIEF SUMMARY OF THE INVENTION

A method is provided of determining the presence of, and polymer identity of, polymer nano-particles in a sample, the method comprising:
(a) exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
(b) identifying one or more regions of interest (ROI) corresponding to a nano-particle in the hyperspectral images or SRS images, and quantifying the intensity of the SRS signal across a predetermined range of wavelengths in said ROI across the hyperspectral images to obtain a detected SRS spectrum in the ROI; and
(c) for each of at least one polymer identity, calculating a respective spectral matching coefficient (SMC_{SRS}) based on the detected SRS spectrum obtained from the ROI and predetermined real or simulated plastic nano-particle standard SRS spectrum data corresponding to the polymer identity; and
(d) for each of the at least one polymer identity determining whether the respective SMC_{SRS} is below a threshold condition corresponding to the polymer identity, wherein if the respective SMC_{SRS} is above the threshold condition, the particle does not correspond to the polymer identity and wherein when the respective SMC_{SRS} is below the threshold condition the particle does correspond to the polymer identity.

A method is provided of determining the presence of, and polymer identity of, polymer nano-particles in a sample, the method comprising:
(a) exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
(b) identifying one or more regions of interest (ROI) corresponding to a nano-particle in the hyperspectral images, and quantifying the intensity of the SRS signal across a predetermined range of wavelengths in said ROI across the hyperspectral images to obtain a detected SRS spectrum in the ROI; and
(c) for each of at least one polymer identity, calculating a respective spectral matching coefficient (SMC_{SRS}) based on the detected SRS spectrum obtained from the ROI and predetermined real standard SRS spectrum data corresponding to the polymer identity; and
(d) for each of the at least one polymer identity determining whether the respective SMC_{SRS} is below a threshold condition corresponding to the polymer identity;

wherein if the respective SMC_{SRS} is above the threshold condition, the particle does not correspond to the polymer identity and wherein when the respective SMC_{SRS} is below the threshold condition the particle does correspond to the polymer identity.

A method of generating a simulated standard SRS for a polymer nanoparticle comprising generating a model therefore using a polystyrene standard nanoparticle, applying said model to a non-polystyrene nanoparticle and determining a threshold value therefore across a range in order to generate a simulated standard SRS for a polymer nanoparticle.

A method of generating a simulated standard SRS spectrum for a microparticle of a compound in a sample comprising:
(a) exposing at least a portion of sample to a pump laser light/narrowband Stokes laser so as to effect hyperspectral stimulated Raman spectroscopy (SRS) on a portion of the sample and collecting any stimulated Raman signal(s) so as to obtain a plurality of hyperspectral stacked images;
(b) identifying one or more regions of interest (ROI) in the hyperspectral stacked images, the ROI containing a microparticle of a compound, and quantifying the intensity of the SRS signal in said ROI across the hyperspectral stacked images to obtain an SRS spectrum in the ROI, and
(c) calculating a spectral matching coefficient (SMC_{SRS}) therefrom, wherein SMC_{SRS} is calculated as follows:

$${SMC}_{SRS} = {min}_{α , 0 \leq β < 1} {‖ x - ( α s + β b ) ‖}_{2} ,$$

wherein c is the obtained SRS spectrum x originating from scaling with an obtained SRS spectrum intensity factor α, wherein s is the normalized bulk standard spectrum, and wherein βb is a background contribution for the system in which the method is being performed at the imaging condition (0≤β<1);
(d) plotting ln(SMC_{SRS}) against SRS intensity α; and calculating therefrom a threshold condition so as to determine a simulated standard SRS spectrum for said microparticle compound.

A method of determining the presence of, and polymer identity of, one or more plastic nano-particles in a sample, the method comprising:
(a) obtaining, by a machine learning module, detected SRS spectrum data from a multiphoton laser scanning microscope configured to perform hyperspectral stimulated Raman scattering microscopy; and
(b) generating, by the machine learning module trained using a training set, as an output the polymer identity of at least one of the one or more plastic nano-particles in the sample, based on a query,
   wherein the training set comprises real and/or synthetic data of SRS spectra associated with respective polymer identities and based on bulk standard spectra, estimated frequency uncertainty, and estimated instrumental noise,
   wherein the query comprises the detected SRS spectrum data,
   and wherein the machine learning module generates the polymer identity based on respective spectral matching coefficients (SMC_{SRS}) of the detected SRS spectrum data obtained and from the training set.

A method of determining a polymer identity output for one or more plastic nano-particles in a sample, the method comprising obtaining, by a machine learning module utilizing an algorithm based on obtaining a query of an SRS spectrum and training set to generate an output of polymer identity, wherein the training set comprises real and/or synthetic data of SRS spectra associated with respective polymer identities and based on bulk standard spectra, estimated frequency uncertainty, and estimated instrumental noise.

A system comprising computer memory and at least one processor operatively connected thereto so as to perform one or more of the methods as described herein. In embodiments the system further comprises a stimulated Raman spectroscopy device comprising one or more of a microscope, a pump laser, Stokes laser and a photodiode.

A computer readable storage medium having data stored therein representing software executable by a computer, the software including instructions to perform one or more of the methods as described herein.

A method of generating a simulated standard SRS for a non-polystyrene polymer nanoparticle comprising:
generating a model of SRS instrumentation noise using a polystyrene standard nanoparticle;
obtaining a standard spectra of the non-polystyrene polymer nanoparticle, applying the model of instrumentation noise to the standard spectra of the non-polystyrene nanoparticle to generate a simulated standard SRA for the non-polystyrene nanoparticle.

A method of determining the identity of one or more nano-particles that share a defined set of spectral features above a detection limit, the method comprising:
a) obtaining SRS spectrum data from a multiphoton laser scanning microscope configured to perform hyperspectral stimulated Raman scattering microscopy;
b) generating, by the machine learning module trained using a training set, the identity of one or more particles, based on the SRS spectrum data, wherein the training set comprises real and/or synthetic data of SRS spectra, associated with respective particle identities and based on bulk standard spectra, estimated frequency uncertainty, and estimated instrumental noise,
wherein the machine learning module generates the particle identity based on respective spectral matching coefficients (SMC_{SRS}) of the detected SRS spectrum data obtained and from the training set.

### BRIEF DESCRIPTION OF THE DRAWINGS

FIGS. 1A-1K: SRS imaging of standard PS micro-nano spheres for detection sensitivity and resolution characterization. A-G, representative SRS images (3050 cm⁻¹) of standard PS micro-nano sphere with different sizes: A) 0.13 μm, B) 0.24 μm, C) 0.29 μm, D) 0.46 μm, E) 0.67 μm, F) 1 μm, G) 3 μm. Scale bar, 2 μm. h, SRS images of 0.24 μm PS nanosphere (3050 cm⁻¹) with 16 nm pixel size. Scale bar, 0.5 μm. i, The normalized intensity distributions along the corresponding dash lines in Figure H. J-K, Linear dependence of the logarithm of stimulated Raman loss signals (Alp/Ip, measured at 3050 cm⁻¹) with the logarithm of particle size in diameter (μm). The Red dashed line shows a linear fitting (R²=0.998) with a slope of 2.98. Error bars, mean±s.d. Red solid line inserted indicates shot-noise-limited SRS detection limit where SNR=1.

FIGS. 2A-2N: Recovering the chemical specificity for polymer identification with SRS-tailored data-driven spectral matching algorithms. A. Normalized SRS spectra of plastic standards (PA, PE, PET, PMMA, PP, PS, and PVC) and a nonplastic standard (4% PFA fixed E. coli embedded in gel). B-C. Examples of particle spectra: B) a typical particle A measured from PA standard particles C) a typical standard PS nanosphere. D-E. Similarity quantification results for particle A and particle B from direct application of conventional spectral-matching algorithms: D) Pearson's correlation coefficients, E) Squared Euclidean Cosine (SEC). The red dashed line indicates the threshold condition determined to have a 95% identification rate of the standard PS nanospheres. The same threshold condition creates elusive identification for particle A, with PA, PP, and PVC all having the similarity measurements close to each other and above the threshold. F. The learning process is indicated by the scatter plot of ln(SMC_{SRS}) against SRS intensity α obtained from (eq.1). Solid data points are simulated plastic particle spectra derived according to the expected error sources from SRS instrument. Light blue ones correspond to the synthetic PS spectrum. The blue circular data points are experimental data from hyperspectral SRS imaging of PS nanospheres of 3 different sizes. The points from the synthetic PS spectrum well colocalize with the points from real experiments on PS nanospheres, which are all far below the data points calculated for synthetic data from other chemical compositions (solid data points in other colors). The red solid line indicates the threshold line drawn for plastic polymer identification g. Confusion matrix for threshold condition evaluation based on experimental plastic particle measurement H-N. Polymer identification results of the example particle A and particle B using SRS-tailored data-driven spectral matching algorithms. In each image of H-N, the black line is the determined threshold from the learning process. The light blue circle from standard PS particle B is confirmed perfectly only with the PS matching scheme having the SMCSRS value below the threshold line (FIG. 2M). The red circle from unknown particle A is unambiguously identified to be PA with only the PA matching scheme having the SMCSRS value below the threshold line (FIG. 2H).

FIGS. 3A-3E: Detecting micro-nano plastics in bottled water: sample preparation, SRS imaging, and data analysis. A. Scheme of the filtration setup for collecting micro-nano plastic particles from bottled water. Two bottles of freshly opened bottled water are filtrated through the 0.2 μm pore-sized Anodisc membrane with carefully cleaned glass apparatuses sealed with aluminum foil. The particles from the water sample are concentrated onto a circular area (d=13 mm) at the center of the membrane. B. Scheme of membrane sandwiching to prepare transparent membrane samples for SRS imaging. The obtained sample (FIG. 3C) is then mounted onto the microscope (FIG. 3D) for hyperspectral SRS imaging. c. The obtained transparent membrane sample is superimposed with a fluorescence image of the standard fluorescent PS particles collected on the membrane, illustrating the uniform particle distribution on a circular surface area with 13 mm diameter in the center of the membrane (Supplementary Note 5). D. Scheme of SRS microscope. Hyperspectral imaging is enabled by tuning the pump laser wavelength and/or the delay line stage inside a commercial Spectral Focusing Timing and Recombination Unit (SF-TRU). When the energy difference between the pump and the Stokes laser matches the vibrational energy of the chemical bond of interest, vibrational excitation happens. Each event is accompanied by one photon loss in the pump beam (stimulated Raman loss, SRL) and one photon gain in the Stokes beam (stimulated Raman gain, SRG). SRS signal is detected by the photodiode as the relative intensity change of the pump beam, which is extracted by the lock-in amplifier to achieve sensitive detection. E. Scheme of automated plastic particle identification. The preprocessed stack of hyperspectral SRS images is sent to a Matlab script for automated plastic particle identification. For each on-resonance image for the target plastic polymer, detected particles are segmented as regions of interest (ROIs) to extract the chemical and morphological information for analysis. For each detected particle, the SRS spectrum is extracted by measuring the intensity of the segmented ROI across the hyperspectral image stack. For particles with SRS peaks in the correct corresponding spectral window, the similarity of the particle spectrum to the target plastic standard is quantified by calculating SMCSRS. The threshold condition is then applied to make the final judgment for the plastic identification of the particle. Morphological information such as size and shape are extracted in the course of image analysis, and statistical pictures composed by each identified individual plastic particle are created subsequently.

FIGS. 4A-4N: Individual micro-nano plastic identified for each target polymer from bottled water. A-G, Representative SRS images of fine plastic particles detected for each polymer: A) Polyamide, B) Polypropylene, C) Polyethylene, D) Polymethyl methacrylate, E) Polyvinyl chloride, F) Polystyrene, G) Polyethylene terephthalate. Scale bar, 0.6 μm. Most of these particles are below 1 μm. H-N, Corresponding SRS spectra of the detected plastic particles. The blue lines are the spectra of detected particles. The orange lines are the matched spectra from the plastic standards.

FIGS. 5A-5F: Quantification of micro-nano plastic exposure from bottled water. A. Averaged number of plastic particles detected per field of view. Error bars, mean±SEM. B. Averaged number of particles for each plastic polymer detected per field of view. Error bars, mean±SEM. Statistically significant differences were determined using generalized linear mixed model analysis with Bonferroni correction. *p<0.05, **p<0.01, ***p<0.001. C. The number of plastic particles estimated in 1 L of bottled water. Error bars, mean±SEM. D. Number proportion of each plastic polymer measured in each brand of bottled water. E. Mass of plastic particles estimated from SRS intensity in 1 L of bottled water. Error bars, mean±SEM. F. Mass proportion of each plastic polymer measured in each brand of bottled water.

FIGS. 6A-6M: Statistical profiles of particles' size and shape for each plastic polymer found in bottled water. A-G. Size distribution of the detected particles for each plastic polymer: A) Polyamide, B) Polypropylene, C) Polyethylene, D) Polymethyl methacrylate, E) Polyvinyl chloride, F) Polystyrene, G) Polyethylene terephthalate. The red shaded area indicates the microplastics. The green shade area indicates the particles with sizes below the optical resolution of SRS microscopy, which are detected in a diffraction-limit pattern. For particles with size above the diffraction limit, the size of the particles is measured by minimum Feret's diameter. For particles detected as diffraction-limited patterns, the actual size of the particles is estimated from SRS intensity harnessing the linear relationship between SRS intensity and the volume of the nanoparticles, assuming nanoplastics exist as a solid sphere. H). Shape distribution of the detected particles for each plastic polymer measured by aspect ratio. I-M). Representative SRS images of plastic particles with various shapes indicated by different aspect ratios. FIG. 15 shows the corresponding SRS spectra. Scale bar, 0.6 μm.

FIG. 7: Raman spectra of plastic standards (PA, PE, PET, PMMA, PP, PS, and PVC) and biomass standard (E. coli).

FIGS. 8A-8B: Comparison of SRS spectra of PS nanospheres in agarose gel prepared by a) H₂O or b) D₂O.

FIG. 9: Raman spectra of H₂O and D₂O.

FIG. 10: High throughput PS nanosphere measurement enabled by single-channel narrow-band SRS imaging. Roughly a thousand 240 nm PS nanoparticles in one FOV (51 μm×51 μm) could be measured under high resolution (pixel size 199 nm) in 1.2 s. Each particle with imaging of a diffraction-limit pattern was analyzed to measure the distribution of SRS intensity for single particles of this specified size. Scale bar: 5 μm.

FIG. 11: SRS intensity distribution of PS nanospheres with different sizes from single particle imaging.

FIG. 12: Spectral sampling from the standard library for high-throughput hyperspectral particle imaging with SRS microscopy. The standard SRS spectra in FIG. 2a were re-sampled at an interval of 5 spectral points, corresponding to a spectral interval of ~15 cm⁻¹. For each spectrum, the corresponding central wavelength for spectral windows from left to right was 897 nm, 886 nm, 804 nm, and 793 nm, respectively. The position was adjusted to best account for the differences in the spectral shape between the spectral standards.

FIGS. 13A-13C: SRS imaging of PS nanospheres on Anodisc aluminum oxide membrane filter A. Representative SRS images (3050 cm⁻¹) of standard 500 nm PS nanospheres on an Anodisc aluminum oxide membrane filter. The SRS images with and without a filter were identical, confirming the presence of the filter does not distort the particle images under the transmissive SRS imaging. Scale bar, 0.6 μm; B. Distribution of SRS intensity of standard 500 nm PS nanospheres measured in agarose gel on the cover glass and on Anodisc filters, respectively. C. The bar chart summarizing the measurement of SRS intensity in b indicates ~70% signal retention of the original signal.

FIGS. 14A-14L: The spectral variation observed for PET particles. 14A-14D. SRS spectra of the representative PET particles with varied spectral features on the high-frequency CH region, most likely due to the presence of heteroaggregates. The blue lines are the spectra of detected particles. The orange lines are the correspondingly scaled standard PET spectrum. E-H. SRS images of the PET heteroaggregates at C═O vibration (1730 cm⁻¹) corresponding to the spectrum above A-D. I-L. SRS images of the PET heteroaggregates at C—H vibration corresponding to the spectrum above A-D. A, E, J spatial chemical heterogeneity within the aggregates can be clearly observed as the SRS images at C—O vibration show clear differences from SRS images at C—H vibration. Scale bar, 0.6 μm.

FIGS. 15A-15E: Corresponding SRS spectrum of representative plastic particles with various shapes indicated by different aspect ratios in FIG. 6. A: Corresponding SRS spectrum of the particle in FIG. 6I, which is identified as PET; B: Corresponding SRS spectrum of the particle in FIG. 6J, identified as PA; C: Corresponding SRS spectrum of the particle in FIG. 6K, identified as PVC. D: Corresponding SRS spectrum of the particle in FIG. 6L identified as PE. E: Corresponding SRS spectrum of the particle in FIG. 6M, identified as PP. The blue lines are the spectrum of detected particles. The orange lines are the matched standard spectrum.

FIGS. 16A-16C: Finding the optimal parameter to simulate frequency uncertainty: A scatter plot of ln(SMCSRS) against SRS intensity α for other plastic standards was generated to compare the experimentally measured PS nanoparticles with simulated PS spectrum on the condition of assuming the instrumental frequency fluctuation is a gaussian distribution with FWHM of a) 5 cm⁻¹ b) 10 cm⁻¹ c) 15 cm⁻¹. Trend lines are fitted with the logarithmic function of a*log(x−c)+b to indicate the trend of the scattered data points.

FIGS. 17A-17F: The learning process indicated by scatter plot of ln(SMCSRS) against SRS intensity α for other plastic standards: A) Polyamide 66 (PA), B) Polypropylene (PP), C) Polyethylene (PE), D) Polymethyl methacrylate (PMMA), E) Polyvinyl chloride (PVC), F) Polyethylene terephthalate (PET). Data of E. coli are also included for comparison. In the legend, the subscript T indicates the synthetic spectral data points of the target polymer in the matching algorithms to evaluate the false negative. The subscript F indicates synthetic spectral data points generated from other polymer types to evaluate the false positive. The red solid lines in each plot are the threshold lines learned from the distribution of labeled synthetic data points. The circular data points are experimental data from hyperspectral SRS imaging of corresponding microplastics.

FIGS. 18A-18D: Confusion matrix on plastic identification performance. a) Plastic identification using Pearson's correlation as similarity measurement. b) Plastic identification using Squared Euclidean cosine as similarity measurement. c) Plastic identification based on SMCSRS measurement with the threshold determined from the data-driven learning process. d) Plastic identification based on final data analysis workflow. After applying the determined threshold on SMCSRS measurement for each polymer, particles identified to be with more than one plastic type are re-evaluated to be the polymer that gives the smallest SMCSRS measurement.

FIGS. 19A-19D: Simulated intensity profile. A) Simulated focal intensity map from the product of the two beams Ip·Is. B) The intensity profile suggests a Gaussian distribution with FWHM of ~400 nm, which matches the experimental measurement. C) Simulated focal intensity map of individual beam Ip or Is. D) The corresponding intensity profile of individual beam (Ip or Is) suggest a Gaussian distribution with the FWHM of 550 nm.

FIGS. 20A-20D: Simulating dependence of SRS signal amplitude vs particles' sizes. a-c) Simulated dependence of SRS signal amplitude vs particles' sizes in diameter plotted in log-log scale. The linear trend line is fitted with data points from particle sizes smaller than a) 500 nm, b) 700 nm, and c) 1.5 μm. A good linear dependence (>0.99) is observed for data points from particle sizes up to 700 nm. d) Effected intensity profile of individual beam interacting with particle used in the simulation, considering the continuous galvo scanning behavior across the particle measurement within the 200 nm sampling pixel size.

FIG. 21: Representative SRS images of plastic standards for each polymer in the library. The SRS intensity of the plastic standard was measured through imaging at the characteristic peak position of the standard spectrum (FIG. 2A). We notice that for most micron particles obtained from crushing the large pallets by freeze mill, the SRS intensity does not present a uniform distribution within the particle. We reason that the brightest signal comes from the situation where the entire focal volume is filled with the target polymer, while other peripheral regions with dim SRS signals might come from compromised solidity in certain areas of the particles. Therefore, we segmented the brightest areas for each plastic standard to measure the RIP for each polymer (Table S3).

FIGS. 22A-22B: Calibration curves for particle size extrapolation A) and mass estimation B) for plastic polymers in the library. The solid line is converted from the experimental measurement of standard PS nanospheres in FIG. 1J. The other calibration curves in dashed lines are converted from the calculation described above. Calibration curves in A are employed for extrapolation of the particle sizes below the diffraction limits, assuming nanoparticles below the diffraction are a solid nanosphere, whose size is measured in diameter. Calibration curves in B are utilized for mass estimation of individual particles, where pixel intensities within the region of interest for each particle are integrated to account for the particles with possible irregular shapes.

FIGS. 23A-23C: Microplastic abundance in the bottled water. A-C. The average number of microplastic particles estimated in 1 L of the bottled water. Particles were counted with sizes larger than A) 1 μm, B) 2 μm, C) 5 μm. Error bars, mean±SEM.

FIGS. 24A-24D: Particle distribution on the Anodisc filter with 0.2 μm pore size indicated by fluorescence PS nanosphere (500 nm). A. Volumetric fluorescence imaging of PS nanospheres on the membrane. B. Histogram plotting the averaged fluorescence intensity measured from individual field of views on the membrane. C, Particle distribution of fluorescent PS nanospheres across the entire filter. Scale bar, 3 mm. D. The intensity profile of the fluorescence signal across the filter. The yellow dots indicate the fluorescence reading from individual pixels across the red dashed line in panel c. The red line indicate the smoothed profile across the membrane.

FIGS. 25A-25D: Micro-nano plastics quantification from analysis using fluorescent PS beads as the internal standard. A. The average number of plastic particles detected in one field of view. Error bars, mean±SEM. B. The number of PVC plastic particles estimated in 1 L of bottled water. Error bars, mean±SEM. C. The number of PET plastic particles estimated in 1 L of bottled water. Error bars, mean±SEM. D. The number of polyamide plastic particles estimated in 1 L of bottled water. Error bars, mean±SEM. Statistically significant differences were determined using generalized linear mixed model analysis with Bonferroni correction. *p<0.05, **p<0.01, ***p<0.001.

### DETAILED DESCRIPTION OF THE INVENTION

Plastics are now omnipresent in our daily life. The existence of microplastics (1 μm to 5 mm in length) and possibly even nanoplastics (<1 μm) has recently raised alarming toxicity and health concerns. In particular, nanoplastics are believed to be more toxic since their smaller size renders them much more amenable, compared to microplastics, to enter the human body. However, detecting nanoplastics impose tremendous analytical challenges on both the nano-level sensitivity and the plastic-identifying specificity, leading to a huge knowledge gap in this mysterious nanoworld surrounding us. To address these challenges, we developed a hyperspectral stimulated Raman scattering (SRS) imaging platform with an automated plastic identification algorithm that allows micro-nano plastic analysis at the single-particle level with high chemical specificity and throughput. We first validated the sensitivity enhancement of the narrow band of SRS to enable high-speed single nanoplastic detection below 100 nm. We then devised a data-driven spectral matching algorithm to address spectral identification challenges imposed by sensitive narrow-band hyperspectral imaging and achieve robust determination of common plastics polymers. With the established technique combining the best detection sensitivity and chemical specificity, we studied the micro-nano plastics from bottled water as a model system. We successfully detected and identified nanoplastics from major plastic types. Micro-nano plastics concentrations were estimated to be about 2.4±1.3×10⁵ particles per liter of bottled water, about 90% of which are nanoplastics. This is orders of magnitude more than the microplastic abundance reported previously in bottled water. High-throughput single-particle counting revealed extraordinary particle heterogeneity and nonorthogonality between plastic composition and morphologies; the resulting multidimensional profiling sheds light on the science of nanoplastics.

A method is provided of determining the presence of, and polymer identity of, polymer nano-particles in a sample, the method comprising:
exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
identifying one or more regions of interest (ROI) corresponding to a nano-particle in the hyperspectral images or SRS images, and quantifying the intensity of the SRS signal across a predetermined range of wavelengths in said ROI across the hyperspectral images to obtain a detected SRS spectrum in the ROI; and
for each of at least one polymer identity, calculating a respective spectral matching coefficient (SMC_{SRS}) based on the detected SRS spectrum obtained from the ROI and predetermined real or simulated plastic nano-particle standard SRS spectrum data corresponding to the polymer identity; and
for each of the at least one polymer identity determining whether the respective SMC_{SRS} is below a threshold condition corresponding to the polymer identity;
wherein if the respective SMCS_{RS} is above the threshold condition, the particle does not correspond to the polymer identity and wherein when the respective SMC_{SRS} is below the threshold condition the particle does correspond to the polymer identity.

In embodiments, predetermined real or simulated plastic nano-particle standard SRS spectrum data corresponding to the polymer identity.

A method is provided of determining the presence of, and polymer identity of, polymer nano-particles in a sample, the method comprising:
exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
identifying one or more regions of interest (ROI) corresponding to a nano-particle in the hyperspectral images, and quantifying the intensity of the SRS signal across a predetermined range of wavelengths in said ROI across the hyperspectral images to obtain a detected SRS spectrum in the ROI; and
for each of at least one polymer identity, calculating a respective spectral matching coefficient (SMC_{SRS}) based on the detected SRS spectrum obtained from the ROI and predetermined real standard SRS spectrum data corresponding to the polymer identity; and
for each of the at least one polymer identity determining whether the respective SMC_{SRS} is below a threshold condition corresponding to the polymer identity;
wherein if the respective SMC_{SRS} is above the threshold condition, the particle does not correspond to the polymer identity and wherein when the respective SMC_{SRS} is below the threshold condition the particle does correspond to the polymer identity.

A method is provided of determining the presence of, and polymer identity of, polymer nano-particles in a sample, the method comprising:
exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
identifying one or more regions of interest (ROI) corresponding to a nano-particle in the hyperspectral images, and quantifying the intensity of the SRS signal across a predetermined range of wavelengths in said ROI across the hyperspectral images to obtain a detected SRS spectrum in the ROI; and
for each of at least one polymer identity, calculating a respective spectral matching coefficient (SMC_{SRS}) based on the detected SRS spectrum obtained from the ROI and simulated SRS spectrum data corresponding to the polymer identity; and
for each of the at least one polymer identity determining whether the respective SMC_{SRS} is below a threshold condition corresponding to the polymer identity;
wherein if the respective SMC_{SRS} is above the threshold condition, the particle does not correspond to the polymer identity and wherein when the respective SMC_{SRS} is below the threshold condition the particle does correspond to the polymer identity.

In embodiments, the detected SRS spectrum comprises detected signals within the predetermined range of wavelengths.

In embodiments, the method further comprises extracting morphological information from the ROI of the hyperspectral stacked images so as to identify, and optionally quantify, one or more morphological parameters of the particle in the ROI.

In embodiments, the calculated SMC_{SRS} is compared to SMC_{SRS} of a library of predetermined real or simulated plastic nano-particle standards SRS spectrum data or wherein the predetermined real or simulated plastic nano-particle standard SRS spectrum data is obtained from a library of plastic nano-particle standards.

In embodiments, when the calculated SMC_{SRS} is below the threshold condition corresponding to more than one polymer identity, determining the corresponding polymer identity based on the lowest SMC_{SRS}.

In embodiments, the at least one Stokes beam is a narrowband Stokes laser pulsed as a picosecond pulse or in the form of spectral focusing of chirped femtosecond pulse.

In embodiments, the SMC_{SRS} is calculated from:

$${SMC}_{SRS} = {min}_{α , 0 \leq β < 1} {‖ x - ( α s + β b ) ‖}_{2} ,$$

wherein c is the detected particle spectrum,
wherein a is a scaling factor corresponding to the intensity of the obtained SRS spectrum,
wherein s is normalized bulk standard spectrum, and
wherein b is a background contribution of the system in which the method is being performed at the imaging condition with 0≤β<1.

In embodiments, SMC_{SRS} is based on the difference between the fitted spectrum (αs+βb) and the detected particle spectrum and/or wherein, the background contribution is obtained by cropping a particle-free area in the same imaging stack as the system in which the method is being performed.

In embodiments, the threshold condition is determined by fitting a logarithmic function (a*log(x−c)+b) wherein x is SRS spectrum intensity and a, b and c are fitting parameters that enable the largest separation between the target nanoplastic and another polymer in a given polymer identity library that has the closest distribution on the scatter plot.

In embodiments, in step a), the plurality of hyperspectral images or plurality of SRS images are obtained by exposing the portion of the sample to wavelengths of 1500 cm⁻¹ to 3200 cm⁻¹, or a narrower subset of this range, or wherein the spectra is determined across a range of wavelengths of 1500 cm⁻¹ to 3200 cm⁻¹, or less.

In embodiments, the spectra is subsampled at a spectral interval of about 15 cm⁻¹.

In embodiments, the size of each ROI corresponds to a single particle.

In embodiments, the methods comprise obtaining one or more additional parameters of the particle in the ROI.

In embodiments, the one or more additional parameters comprises morphological data.

A method of generating a simulated standard SRS for a polymer nanoparticle comprising generating a model therefore using a polystyrene standard nanoparticle, applying said model to a non-polystyrene nanoparticle and determining a threshold value therefore across a range in order to generate a simulated standard SRS for a polymer nanoparticle.

A method of generating a simulated standard SRS spectrum for a microparticle of a compound in a sample comprising:
exposing at least a portion of sample to a pump laser light/narrowband Stokes laser so as to effect hyperspectral stimulated Raman spectroscopy (SRS) on a portion of the sample and collecting any stimulated Raman signal(s) so as to obtain a plurality of hyperspectral stacked images;
identifying one or more regions of interest (ROI) in the hyperspectral stacked images, the ROI containing a microparticle of a compound, and quantifying the intensity of the SRS signal in said ROI across the hyperspectral stacked images to obtain an SRS spectrum in the ROI, and
calculating a spectral matching coefficient (SMC_{SRS}) therefrom, wherein SMC_{SRS} is calculated as follows:

$${SMC}_{SRS} = {min}_{α , 0 \leq β < 1} {‖ x - ( α s + β b ) ‖}_{2} ,$$

wherein c is the obtained SRS spectrum x originating from scaling with an obtained SRS spectrum intensity factor a, wherein s is the normalized bulk standard spectrum, and wherein βb is a background contribution for the system in which the method is being performed at the imaging condition (0≤β<1);
plotting ln(SMC_{SRS}) against SRS intensity a; and
calculating therefrom a threshold condition so as to determine a simulated standard SRS spectrum for said microparticle compound.

In embodiments, the microparticle comprises a plastic.

In embodiments, the simulated plastic nano-particle standard SRS spectrum is obtained by conducting simulation based on a known plastic nano-particle standard SRS spectrum with one or more parameters.

In embodiments, the one or more parameters comprise noise on SRS intensity.

In embodiments, the one or more parameters comprise frequency uncertainty.

In embodiments, the frequency uncertainty is instrumental frequency fluctuation.

In embodiments, the instrumental frequency fluctuation is a gaussian distribution.

In embodiments, the gaussian distribution has a full width at half maximum (FWHM) of 10 cm⁻¹.

In embodiments, the plastic comprises polyamide 66 (PA), polypropylene (PP), polyethylene (PE), polymethyl methacrylate (PMMA), polyvinyl chloride (PVC), polystyrene (PS), and polyethylene terephthalate (PET).

In embodiments, the known plastic nano-particle standard SRS spectrum is nano-particle standard SRS spectrum of PS.

A method of determining the presence of, and polymer identity of, one or more plastic nano-particles in a sample, the method comprising:
obtaining, by a machine learning module, detected SRS spectrum data from a multiphoton laser scanning microscope configured to perform hyperspectral stimulated Raman scattering microscopy; and
generating, by the machine learning module trained using a training set, as an output the polymer identity of at least one of the one or more plastic nano-particles in the sample, based on a query,
wherein the training set comprises real and/or synthetic data of SRS spectra associated with respective polymer identities and based on bulk standard spectra, estimated frequency uncertainty, and estimated instrumental noise,
wherein the query comprises the detected SRS spectrum data,
and wherein the machine learning module generates the polymer identity based on respective spectral matching coefficients (SMC_{SRS}) of the detected SRS spectrum data obtained and from the training set.

In embodiments, the machine learning module employs an algorithm calculating SMC_{SRS} from:

$${SMC}_{SRS} = {min}_{α , 0 \leq β < 1} {‖ x - ( α s + β b ) ‖}_{2} ,$$

wherein c is the detected particle spectrum,
wherein a is a scaling factor corresponding to the intensity of the obtained SRS spectrum,
wherein s is normalized bulk standard spectrum, and
wherein βb is a background contribution of the system in which the method is being performed at the imaging condition (0≤β<1).

A method of determining a polymer identity output for one or more plastic nano-particles in a sample, the method comprising obtaining, by a machine learning module utilizing an algorithm based on obtaining a query of an SRS spectrum and training set to generate an output of polymer identity, wherein the training set comprises real and/or synthetic data of SRS spectra associated with respective polymer identities and based on bulk standard spectra, estimated frequency uncertainty, and estimated instrumental noise.

In embodiments, the query comprises the detected SRS spectrum data. In embodiments, the machine learning module generates the polymer identity based on respective spectral matching coefficients (SMC_{SRS}) of the detected SRS spectrum data obtained and from the training set.

In embodiments, the spectral matching coefficients are calculated using a computer with memory and a least one processor

A system comprising computer memory and at least one processor operatively connected thereto so as to perform one or more of the methods as described herein. In embodiments the system further comprises a stimulated Raman spectroscopy device comprising one or more of a microscope, a pump laser, Stokes laser and a photodiode.

A computer readable storage medium having data stored therein representing software executable by a computer, the software including instructions to perform one or more of the methods as described herein.

A method of generating a simulated standard SRS for a non-polystyrene polymer nanoparticle comprising:
generating a model of SRS instrumentation noise using a polystyrene standard nanoparticle;
obtaining a standard spectra of the non-polystyrene polymer nanoparticle,
applying the model of instrumentation noise to the standard spectra of the non-polystyrene nanoparticle to generate a simulated standard SRA for the non-polystyrene nanoparticle.

A method of determining the identity of one or more nano-particles that share a defined set of spectral features above a detection limit, the method comprising:
a) obtaining SRS spectrum data from a multiphoton laser scanning microscope configured to perform hyperspectral stimulated Raman scattering microscopy;
b) generating, by the machine learning module trained using a training set, the identity of one or more particles, based on the SRS spectrum data
wherein the training set comprises real and/or synthetic data of SRS spectra, associated with respective particle identities and based on bulk standard spectra, estimated frequency uncertainty, and estimated instrumental noise
wherein the machine learning module generates the particle identity based on respective spectral matching coefficients (SMC_{SRS}) of the detected SRS spectrum data obtained and from the training set.

In embodiments, the defined set of spectral features is 10 or fewer, 8 or fewer, 5 or fewer, or 3 or fewer.

In embodiments, the nano-particles are organic molecule nanoparticles.

In embodiments, the nano-particles are hydrocarbon nanoparticles.

In embodiments, the nano-particles are carbon nanoparticles.

In embodiments, the nano-particles are silicon nanoparticles.

In embodiments, the nano-particles are metal-organic nanoparticles.

Various inventive concepts may be embodied as a non-transitory computer readable storage medium (or multiple non-transitory computer readable storage media) (e.g., a computer memory of any suitable type including transitory or non-transitory digital storage units, circuit configurations in Field Programmable Gate Arrays or other semiconductor devices, or other tangible computer storage medium) encoded with one or more programs that, when executed on one or more computers or other processors, perform methods that implement one or more of the various embodiments described above. When implemented in software (e.g., as an app), the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

In embodiments, the methods and algorithms employed may be incapable of being performed by hand—e.g., with pen and paper.

Also, a computer may have one or more communication devices, which may be used to interconnect the computer to one or more other devices and/or systems, such as, for example, one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Also, a computer may have one or more input devices and/or one or more output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

The non-transitory computer readable medium or media may be transportable, such that the program or programs stored thereon may be loaded onto one or more different computers or other processors to implement various one or more of the embodiments described above. In embodiments, computer readable media may be non-transitory media.

The terms “program,” “app,” and “software” are used herein in a generic sense to refer to any type of computer code or set of computer-executable instructions that may be employed to program a computer or other processor to implement various embodiments as described above. Additionally, it should be appreciated that, according to one aspect, one or more computer programs that when executed perform methods of this application need not reside on a single computer or processor but may be distributed in a modular fashion among a number of different computers or processors to implement various embodiments of this application.

Computer-executable instructions may be in many forms, such as program modules, executed by one or more computers or other devices. Generally, program modules include routines, programs, objects, components, data structures, etc. that perform particular tasks or implement particular abstract data types. The functionality of the program modules may be combined or distributed as desired in various embodiments.

Databases, if employed in the methods or devices or systems herein, may include computer readable memory (also referred to as ‘memory’). For example, data storage space 3mem1N may be and/or include computer readable memory, used to store data as described in the disclosure. Memory may be embodied by suitable hardware, including but not limited to the following: hard disk drives, serial advanced technology attachment (SATA) hard drives, SATA solid state drives (SSDs), non-volatile memory express (NVMe) SSDs, tape drives.

Also, data in databases may be stored in computer-readable media in any suitable form. For simplicity of illustration, databases may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

Herein we introduce a data-science-driven hyperspectral stimulated Raman scattering (SRS) microscopy as a powerful platform of nanoplastics detection to meet the three requirements. SRS microscopy utilizes stimulated Raman spectroscopy as the imaging contrast mechanism and has found increasing utility in biomedical imaging[31-35]. While SRS is often credited for speeding up regular Raman imaging by over 1,000 times[33-36], which enables fast identification of microplastics[37-38], whether it can reach the detection limit of nanoplastic remains unknown. To maximize the sensitivity needed for detecting individual nanoplastic, we adopted a narrowband SRS imaging scheme by focusing all the energy of the stimulating beam to target characteristic vibrational modes with the largest Raman cross-sections[39]. We then showed, both theoretically and experimentally, narrowband SRS imaging can enable the detection of nanoplastic as small as 100 nm. However, the limited spectral features from only the strongest vibrational signatures above the detection limit impose challenges on automated spectrum identification, which is essential for high-throughput plastic particle analysis. To address this fundamental sensitivity-specificity trade-off and unleash the full potential of hyperspectral SRS imaging, we devised a data-driven SRS-tailored spectral matching algorithm based on the spectral library of 7 common plastic standards. The intrinsic chemical specificity from vibrational signatures in the shape of SRS spectroscopy is successfully recovered for automated polymer identification for nanoplastic detection with the help of the data-driven algorithm.

Equipped with this platform, we then studied micro-nano plastics in daily consumed bottled water as a prototype of a real-life sample. Individual particles for all seven plastic polymers from the library were identified, enabling statistical analysis of plastic particles with sizes down to 100-200 nm. The exposure to micro-nano plastics was estimated with specified polymer composition. Integrating morphological information from single particle imaging, multi-dimensional characterizations of individual plastic particles are reported, unveiling the all-around heterogeneities of plastic particles in a hidden micro-nano world encircling us. Our results can shed light on the science of nanoplastics.

2. SRS Imaging of Polystyrene Nanospheres with Single Particle Sensitivity

SRS microscopy is well known to be orders of magnitude faster than regular Raman imaging. The former has a typical pixel dwell time of 1~100 μs, but the latter often needs 10 ms~1 sec per pixel[32-33]. The drastically higher imaging speed of SRS microscopy hence provides high throughput on particle imaging. However, whether high-speed SRS has a better detection limit than regular Raman and whether it can actually reach the single-particle sensitivity of nanoplastics are not obvious. It is possible that the limit of detection is compromised under the high imaging speed for SRS. A theoretical investigation is helpful in the first place. For a given major type of plastic polymer, we can estimate the mass of a 100 nm-diameter nanoplastics based on the plastic density. The number of repeating units (i.e., constituting monomer) can then be calculated via its molecular weight. As shown in Table S1, this number is around 10⁶ for most major plastic types. By considering the structural nature of the monomers, we then further estimated the number of most abundant chemical bonds in a single plastic particle to be ~10⁷.

TABLE S1
Number of Repeating units in 100 nm Particles from common plastic types.

| | | | | 100 nm nanoplastics | |
|---|---|---|---|---|---|
| | | | | (assuming | |
| | | | | solid sphere) | |
| | | | | | Number |
| | | | | | of |
| | | | | | repeating |
| Plastics | | Unit | Density | Mass | units |
| polymer | Chemical structure | M.W. | (g/cm³) | (× 10 [symbol] g) | (× 10⁶) |
| Polyethylene (PE) | 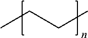 | 28.05 | 0.87-0.96 0.95* | 4.6-5.0 | 9.8-10.8 |
| Polypropylene (PP) | 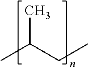 | 42.08 | 0.84-0.91 0.91* | 4.4-4.8 | 6.3-6.8 |
| Polyamide Nylon 66 (PA) | 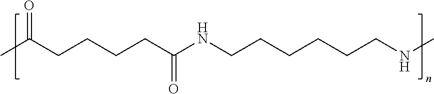 | 226.32 | 1.05-1.14 1.14* | 5.5-6.0 | 1.5-1.6 |
| Polystyrene (PS) | 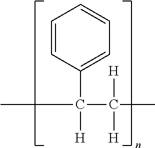 | 104.15 | 1.02-1.06 1.02* | 5.3-5.6 | 3.1-3.2 |
| Poly(methyl methacrylate) (PMMA) | 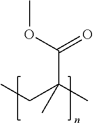 | 100.12 | 1.17-1.20 1.18* | 6.1-6.3 | 3.7-3.8 |
| Polyvinyl chloride (PVC) | 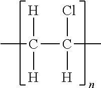 | 62.50 | 1.37-1.43 1.38* | 7.2-7.5 | 6.9-7.2 |
| Polyethylene terephtalate (PET) | 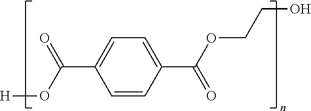 | 192.17 | 1.3-1.4 1.38* | 6.8-7.3 | 2.1-2.3 |

All the density information is obtained from ref [1]. For polymers that have a range of density depending on the different forms of
existence, * is utilized for the following mass calibration. [symbol]
indicates data missing or illegible when filed

Based on the above quantification, we can theoretically explain why a 100 nm nanoplastic particle is extremely difficult to be detected by conventional Raman microscopy. The spontaneous Raman cross-section of a typical C—H vibration is about 10⁻²⁹ cm². Hence the spontaneous Raman cross-section of a 100 nm nanoparticle is 10⁻²² cm². The laser waist area can be shrunk to about 2×10⁻⁹ cm² under a high numerical aperture microscope objective. The probability of Raman scattering event per excitation photon is then (10⁻²² cm²)/(2×10⁻⁹ cm²)=5×10⁻¹⁴. Assuming a moderately high laser power of 10 mW with a conventional 532 nm laser, which corresponds to an excitation flux of 3×10¹⁶ photons/see, and a rather long acquisition time of 100 milliseconds (a small 128×128 image will take half an hour), only about 150 photons can be generated per particle in total via spontaneous Raman scattering. Considering the quantum yield of the entire instrument (including objective, filters, pinhole, spectrometer, and camera) typically is ~1%, roughly only 1.5 photons can be ultimately detected, which can be easily overwhelmed by noise from other backgrounds such as autofluorescence. One can also compare a nanoparticle to a typical fluorescent dye (such as rhodamine) whose absorption cross section is ~10⁻¹⁶ cm². Raman signal from a single nanoplastic particle will be a million times weaker (10⁻²²/10⁻¹⁶) than a single-molecule fluorescence signal. Detecting such a feeble signal has rarely been reported in the photonics field.

We are now in a position to predict the performance of SRS for nanoplastic imaging. By employing an additional coherent Stokes laser, SRS amplifies the feeble scattering crossing section of a specific spectral mode (defined by the energy difference between pump and Stokes lasers) via quantum stimulation. When a pulsed narrowband Stokes laser is used either in the form of a picosecond pulse or in the form of spectral focusing of chirped femtosecond pulse[31, 40], the stimulated Raman enhancement factor can be maximized to more than 10⁸ as measured in microscopy configuration[39, 41]. Then the stimulated Raman cross-section of a nanoparticle is amplified from 10⁻²² cm² to ~10⁻¹⁴ cm². The probability of a stimulated Raman scattering event per pump excitation photon becomes (10⁻¹⁴ cm²)/(2×10⁻⁹ cm²)=5×10⁻⁶, which is measured as a stimulated Raman loss experienced by the pump beam targeting C—H vibration. The noise of the pump beam under high-speed SRS microscopy acquisition (18 μs/pixel) is measured to be 5×10⁻⁷, which is about ten times lower than the expected stimulated Raman loss signal from a single 100-nm plastic particle. Thus, we predict that narrowband SRS shall break the detectability barrier of spontaneous Raman and bring a single nanoplastic particle into detection in just tens of microseconds.

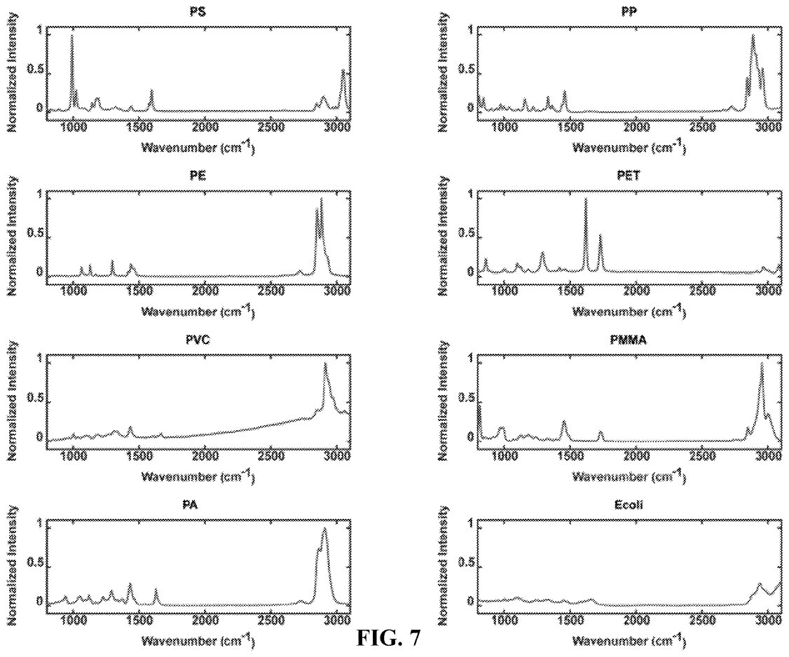

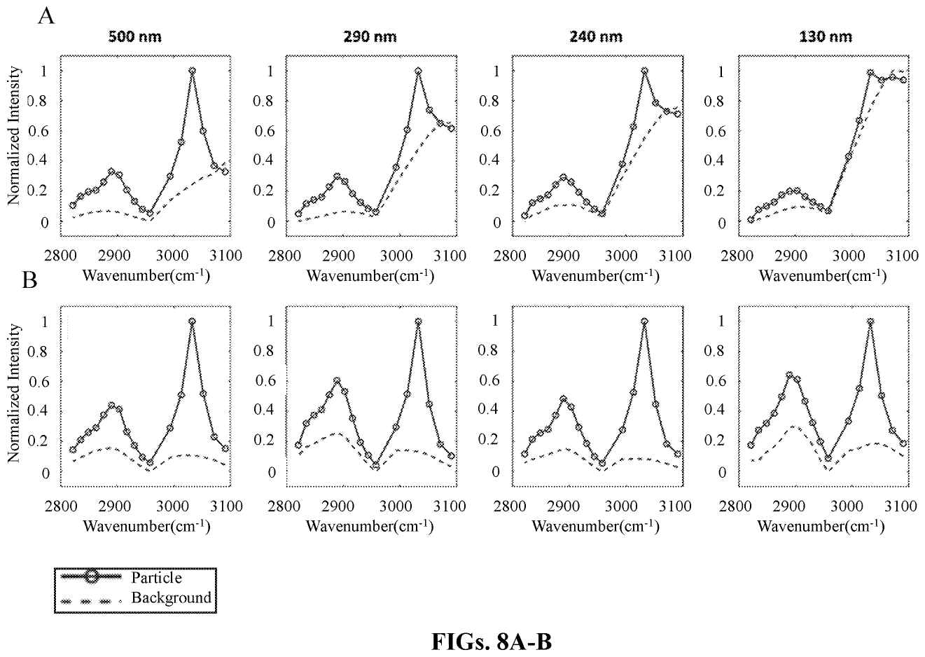

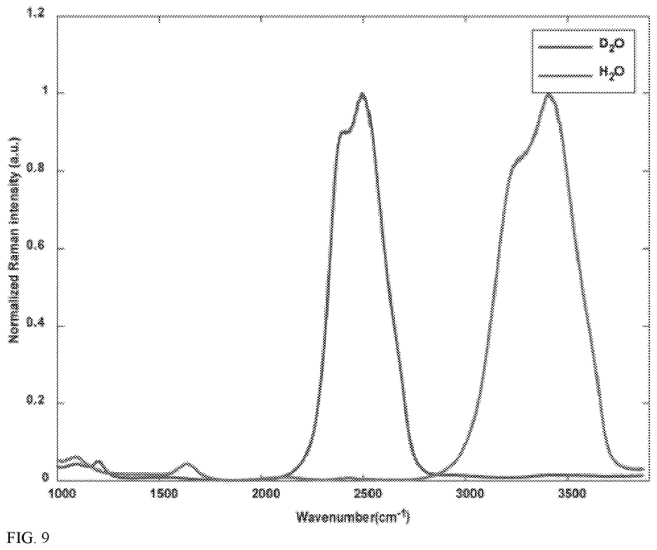

We then experimentally verify the superb detection sensitivity using standard plastic particles. Polystyrene is one of the most common plastics widely used in daily life. Polystyrene particles of specified sizes are commercially available as analytical chemistry standards and have been routinely used as a model material to study micro-nanoplastics[42-43]. The Raman spectrum of polystyrene suggests a prominent peak at 3050 cm⁻¹ from aromatic C—H vibration on the phenyl ring (FIG. 7), which can be selectively amplified for SRS imaging by tuning the difference of pump and Stokes beams to match this transition energy. Using commercial PS micro-nano spheres from 100 nm to 3 μm, we evaluated the detection sensitivity of our SRS microscope in imaging nanoplastics. To stabilize the particles during imaging, we embedded the diluted PS particles in agarose gel. As the particle size goes smaller, the residue of the water background around 3000 cm⁻¹ starts to dominate (FIG. 8A), overwhelming the authentic spectrum of individual PS nanoparticles. To resolve this background issue for better imaging contrast, we substituted regular H₂O with D₂O to prepare the agarose gel (FIG. 8B). Compared to H₂O, the Raman spectrum of D₂O is red-shifted to the silent region (2200 cm⁻¹-2800 cm⁻¹, FIG. 9), creating a background-free environment for probing C—H vibration.

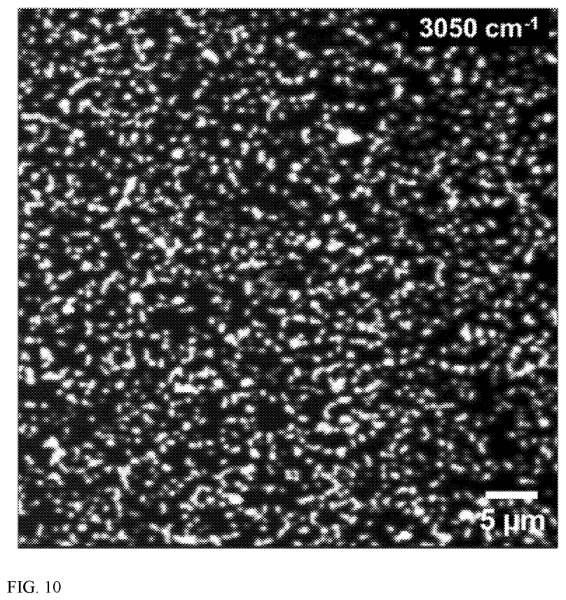

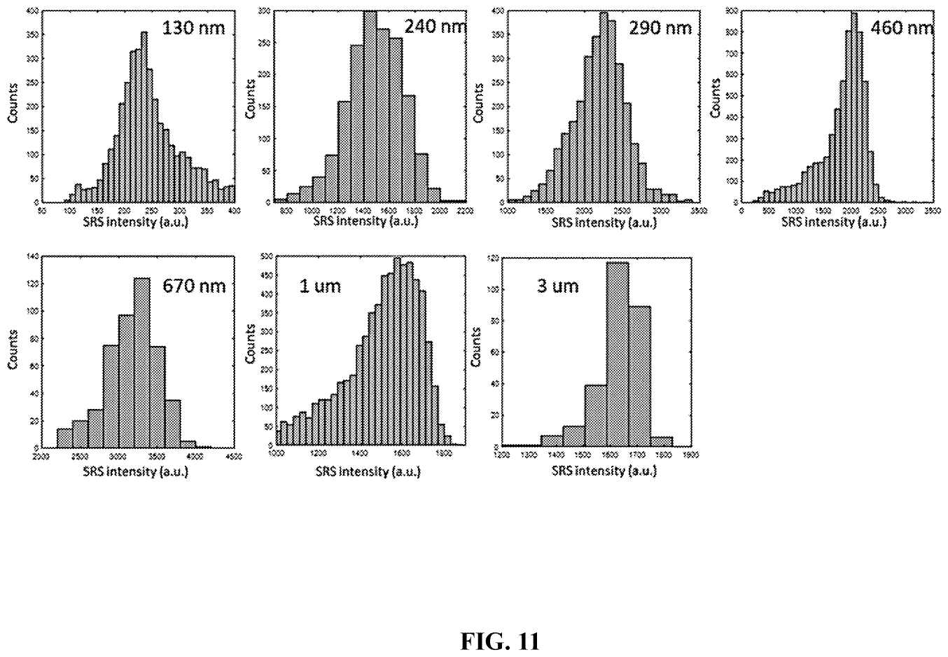

SRS intensity of individual particles can be thereby measured from single-channel narrow-band imaging with high throughput (~1000 particles in one 51 μm×51 μm FOV within 2 s, FIG. 10). This imaging speed is orders of magnitude faster than other nanoplastic imaging techniques, such as AFM-IR and STXM[27-28, 30]. With the optical diffraction limit, the optimal spatial resolution of SRS microscopy is measured to be 365 nm. With a spatial sampling of 200 nm pixel size for high-throughput imaging, individual PS nanospheres of above 500 nm can be discerned with their shape from the images. When the size of the particles goes smaller than the diffraction limit, the finite optical resolution renders the particle image a diffraction-limited pattern. Yet, the SRS intensity of a single particle can still be readily recognized down to 100 nm based on the diffraction limit pattern and the intensity distribution (FIG. 11). Thus experimentally, we have shown that compared to regular spontaneous Raman, SRS imaging can offer orders of magnitude higher imaging speed/throughput and a superior limit of detection of nanoplastics.

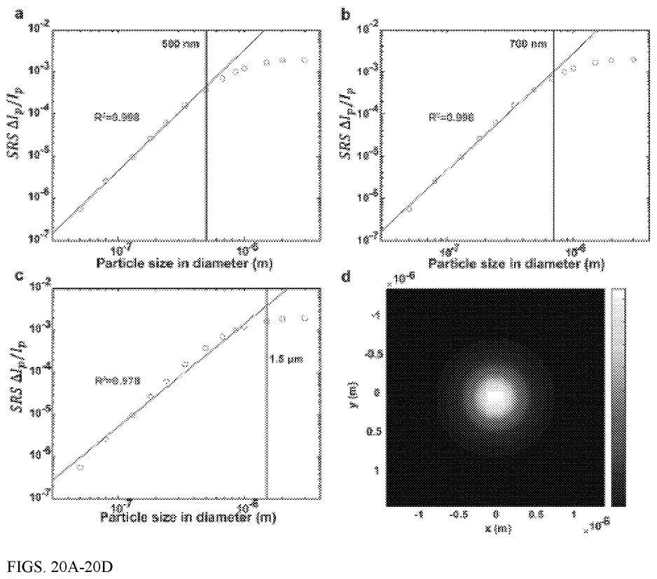

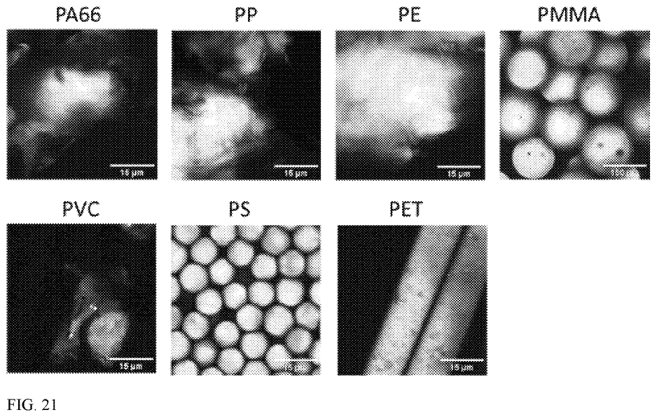

A linear relationship was observed between the logarithm of SRS signal (ΔIₚ/Iₚ) and the logarithm of diameter for PS particles smaller than 0.7 μm, (Supplementary Note 3). The trendline with a slope of 2.98 within the range indicates the SRS signal (ΔIₚ/Iₚ) increase linearly with the particles' volume, which scales in cubic as the particles' diameters increase. When the particles' size is enlarged to overfill the effective focal volume sequentially in first x, y, and later z dimensions (FIG. 20), the linear dependency disappears. This good linearity (R²=0.998) is due to the fundamental linear dependency of the SRS signal on the concentration of the target analyte, providing powerful utilities in several aspects. First, the actual size of particles below the diffraction limit can be estimated based on the obtained calibration curve (FIG. 20A), extending the size characterization limit. Secondly, with the known information on the plastic density, the same calibration curve can be transformed into a reference to deduce a particle mass out of a detected SRS nanoplastics image (Supplementary Note 3, FIG. 20B). Finally, taking an SNR of one as the threshold, the detection limit of our narrowband SRS microscope can be determined to reach PS nanospheres down to 60 nm.

3. Fundamental Challenges on Chemical Identification of Nanoplastics with Hyperspectral SRS Imaging

Nano-sensitivity solves the first-order issue to ensure the plastic particles are detectable. The chemical specificity of a technique is also crucial to identify plastics from other co-existing substances and further distinguishing plastic polymers from each other. Harnessing vibrational spectroscopy as imaging contrast, SRS microscopy, in principle, holds the demanded specificity for chemical imaging. Instrumentally, we perform hyperspectral SRS imaging via spectral-focusing technique[44-45]. Choosing the central pump wavelength is critical under this hyperspectral SRS regime as it will determine the detective range of the target Raman spectral window. To best cover the characteristic strong feature of the plastic Raman spectrum (FIG. 7) within the tuning range of the instrument (790 nm-910 nm), we carefully choose 793 nm, 804 nm, 886 nm and 897 nm as four central wavelengths to include the strong and characteristic spectral features of C—H (unsaturated and saturated carbons, 3110 cm⁻¹-2800 cm⁻¹), ester bonds (1770 cm⁻¹-1670 cm⁻¹), and double bond vibration (1660 cm⁻¹-1580 cm⁻¹) for better distinguishment between each plastic type. We constructed a small library by measuring the bulk SRS spectra of 7 most common plastic polymers: polyamide 66 (PA), polypropylene (PP), polyethylene (PE), polymethyl methacrylate (PMMA), polyvinyl chloride (PVC), polystyrene (PS), and polyethylene terephthalate (PET) with fine spectral intervals (~3 cm⁻¹).

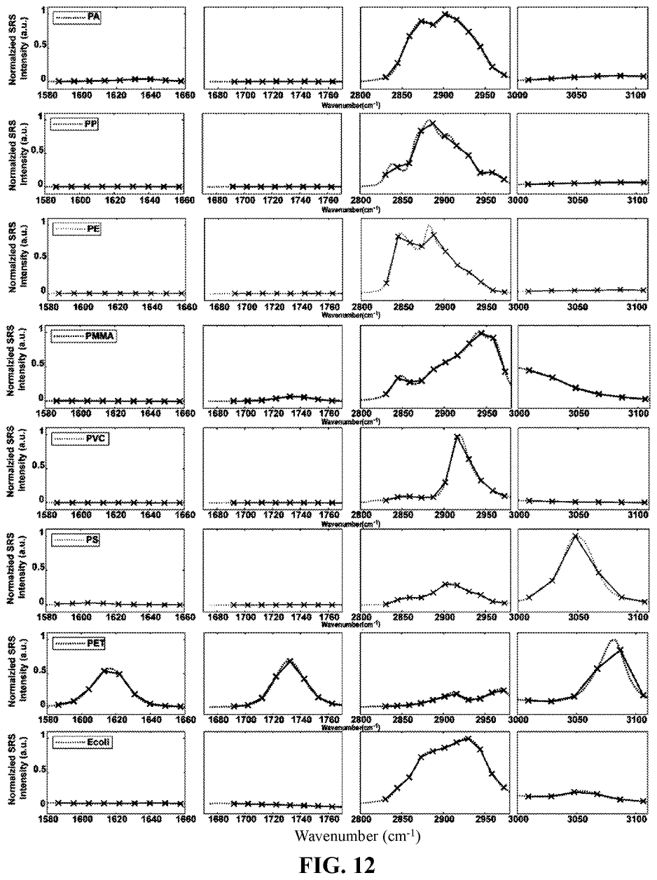

Unlike bulk spectra measurement, single particle imaging of nanoplastics requires a much smaller pixel size, longer integration time, and higher power for optimal signal-to-noise ratio. Therefore, due to the fundamental trade-off between detection sensitivity and specificity, it is nearly impossible to measure nanoplastics with such fine spectral intervals (hours of imaging time per FOV with increasing possibility of sample drifting and burning during the time). Moreover, the spectral resolution of a hyperspectral SRS microscope based on spectral focusing is typically 10-25 cm⁻¹. For efficient hyperspectral imaging with a proper balance between throughput and spectral resolution, we further subsampled the spectra (FIG. 12) with the spectral interval of ~15 cm⁻¹, which is only slightly above the spectral resolution and yielded acceptable imaging throughput (~0.5 h per 0.2 mm×0.2 mm FOV) for single-particle chemical imaging of nanoplastics.

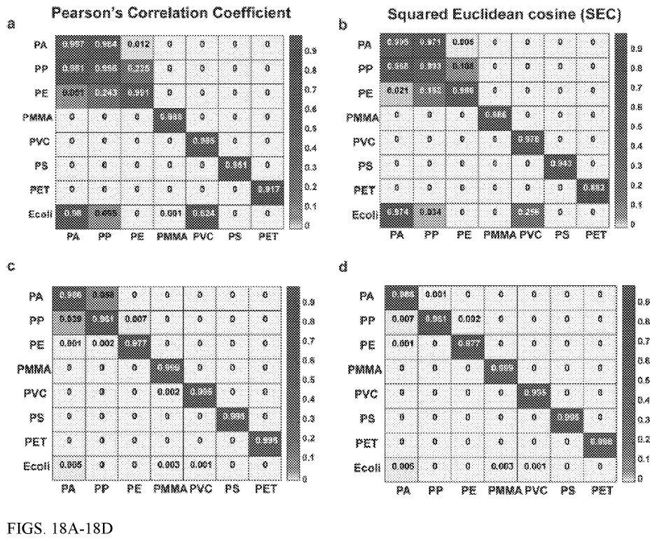

High-throughput plastic particle analysis also requires automated spectral analysis for plastic identification. Spectral matching algorithms for automated chemical identification are prevalently adopted in microplastic analysis based on FTIR or Raman spectroscopy[46-47]. With thousands of particle spectra in need of analysis in a typical environmental study, manual plastic identification and counting are not only impossibly labor-intensive but also subjected to human bias[17, 46-48]. Automated particle analysis helps to speed up the measurement, analyze more particles, as well as ensure ubiquitous and unbiased plastic identification. Understanding the need for automation in environmental science, we started with applying the classic library matching algorithms in FTIR and Raman analysis but found them not so compatible with narrow-band SRS hyperspectral analysis. Take a detected spectrum from particle A prepared from grinding the PA standard as an example. After spectrum pre-processing on background subtraction and data normalization, the spectrum of particle A clearly matches the SRS signature of polyamide. However, when measuring the spectral similarities of particle A to bulk plastic standards from the library using common spectral matching algorithms[48], such as Pearson's correlation coefficient (PC) or squared Euclidean cosine (SEC) measurement, the identification results appears elusive. In a real-life sample analysis, there should be no premise to assume particle A should belong to any standard plastics in the library, which means a yes or no judgment has to be made independently for each plastic standard based on a given threshold. The common threshold employed in FTIR or spontaneous Raman analysis of microplastics is the similarity measurement above 0.7, which is clearly too low to identify Particle A, as any plastics other than PS and PET are above the threshold. Since PS nanoparticles are available as model standards for nanoplastics analysis, we first try to study the similarity threshold for each algorithm under hyperspectral SRS imaging. The similarity threshold is then determined based on the quartile of identifying at least 95% of the PS particles (similarity index above 0.75 for PC, and similarity index above 0.94 for SEC). The challenging part of making a binary identification judgment remains in the case of particle A as similarity measurements from three plastic polymers (PA, PP, and PVC) are very close in number and all above the threshold. Note that one cannot simply pick the best score among all the standards because it is totally possible for A to be nonplastic materials in real sample analysis. In fact, if we simulate the possible nonplastic SRS spectra based on the model standard spectrum of biomass represented by E. coli, over 95% of them will have similar measurements against PA standard over the given threshold for both two algorithms (FIG. 18A, B).

We reflect that the main reason underlying the above difficulty stems from the trade-off between detection sensitivity and specificity. Emphasizing the chemical specificity, spontaneous Raman spectroscopy or other broadband coherent Raman microscopy can cover an extended spectral window (>1000 cm⁻¹) by distributing the optical power among a large number of Raman vibrational modes. The rich spectral information can enable chemical identification with simple algorithms but comes with the cost of over thousand times compromised detection sensitivity if not using some special non-commercialized instrumentation[49-51]. However, in the context of nanoplastics analysis, detecting the particle signal is the premise before chemical identification from the vibrational spectrum. With the aim of measuring as small plastic particles as possible under practical throughput, eventually, only the strongest Raman features will be detectable with reasonable SNR. For most plastics, which are organic polymers by nature, the strongest Raman signatures reside within the limited C—H vibration window. In this case, specific chemical identification requires the algorithms to precisely capture the shape feature within the restricted spectral window, which is beyond the capacity of conventional spectral matching algorithms. Moreover, the inevitably compromised circumscribed signal-to-noise ratio when imaging diminutive nanoparticle create further challenges in spectral interpretation for robust chemical identification. Therefore, new methods are demanded to address the specificity challenge imposed by the SRS instrumentation that enables unprecedented sensitivity in imaging nanoplastics.

### 4. Data-Driven SRS-Tailored Spectral Matching Algorithm Recovers Chemical Specificity

Harnessing data science, we aim to develop novel algorithms that can better interpret the shape of detected SRS features and retrieve the chemical specificity for polymer identification. First, an SRS-tailored spectral matching coefficient (SMCSRS) is developed as an indicator to quantify spectral similarity with minimized noise interference (eq. 1). SMCSRS uses an optimization algorithm that considers the detected SRS spectrum x originating from scaling (intensity factor α) the normalized bulk standard spectrum s, plus a certain background contribution at the imaging condition (βb, 0≤β<1). The fitted spectrum (αs+βb) was compared with the detected particle spectrum x to find the minimum possible spectral distance as SMCSRS. The smaller SMCSRS value indicates a higher spectral similarity to the corresponding standards. This novel indicator SMCSRS provides several advantages for the purpose of detecting nanoplastics over the conventional feature extraction algorithms for spectral similarity measurement. The optimization algorithm considers all spectral points simultaneously, which reduces the direct influences induced by the noise on each particular spectral point. Such an essentially fitting process leverages the reliability of the similarity measurement. In addition, the outcome of the measurement is interpretable. The well-defined intensity factor α and background factor β can indicate the contribution from each spectral component (the particle and the surrounding backgrounds). Finally, the spectral distance measurement provides metric similarity evaluation.

With the spectral similarity quantified in this refined way, we returned to face the challenge of making a nonarbitrary binary judgment for polymer identification. We planned to develop a learning-based method to determine the previously elusive binary threshold for the identification of all plastic polymers. Our premise is that if we can measure the nanoparticle spectra for all types of plastics within the library, we shall be able to learn from the data and draw the correct boundary for identification based on the distribution of the particles with known identities. However, in reality, only PS nanospheres are commercially available with well-characterized chemical composition and nano sizes. Without reliable ground truth from other polymer nanoparticles, we have to seek alternative ways to gather the massive information needed for rigorous threshold determination.

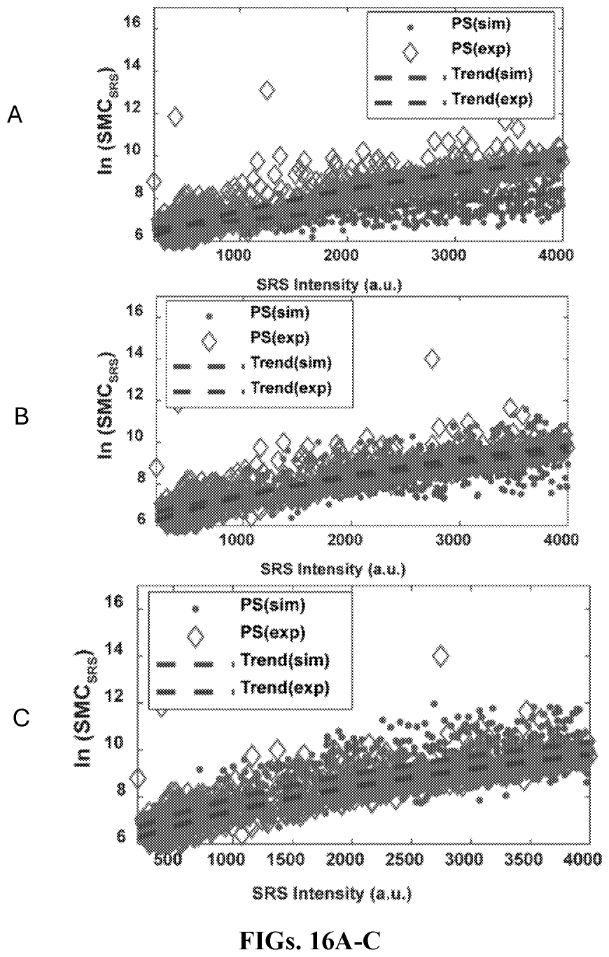

Inspired by the increasing utilities of synthetic data in artificial intelligence[52], and the growing involvement of data science in SRS microscopy[53-56], we realized that we could simulate the experimental SRS spectra of nanoplastics from the bulk standard spectra to serve as a training data set (i.e., synthetic data). Based on our understanding of the SRS instrumentation, we proposed a model, where there are two main sources of noise in a typical hyperspectral SRS spectrum: one is fundamental noise on the SRS intensity as in a shot-noise-limited scenario, which can be easily read out from the same SRS image; the other is the frequency uncertainty imposed by the SRS instrumentation, where both the laser profile and the moving delay stage can result in fluctuation of the actual frequency excited in each measurement around the preset spectral points. Assuming the fluctuation follows a Gaussian distribution, we used PS nanospheres as the standard model to investigate the fluctuation range and found an impressive consistency in SMCSRS calculation from the synthetic spectra and measured spectra of PS nanoparticles (Supplementary Note 2, FIG. 16). The combinatory nature of noise origins explains the dependency of the SMCSRS value on the intensity of the spectrum (a), as suggested in the simulation and validated by the experiment.

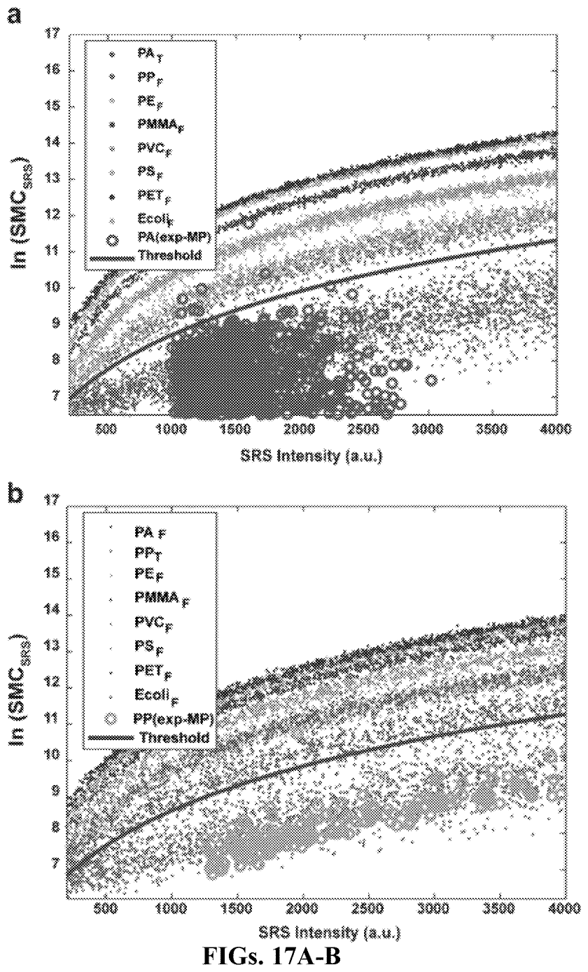

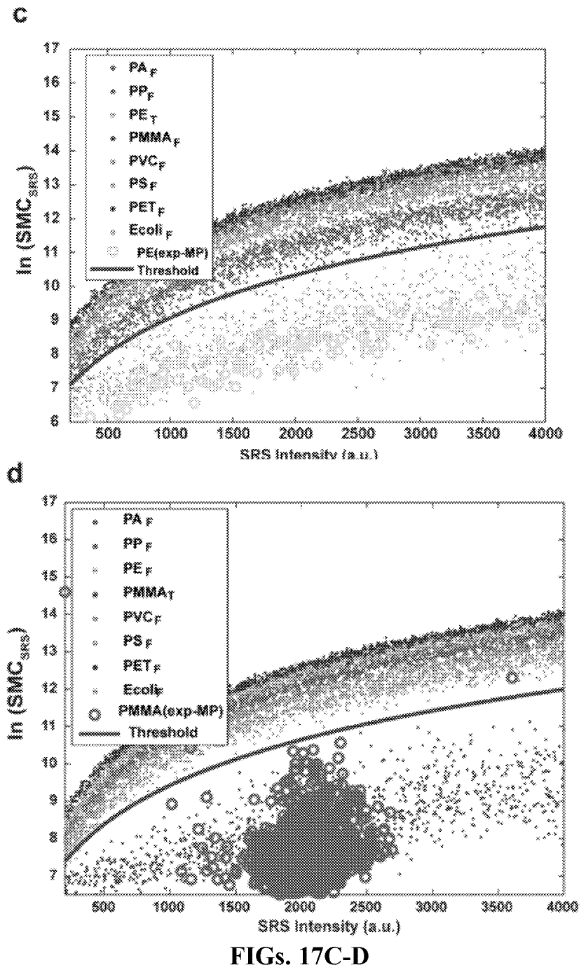

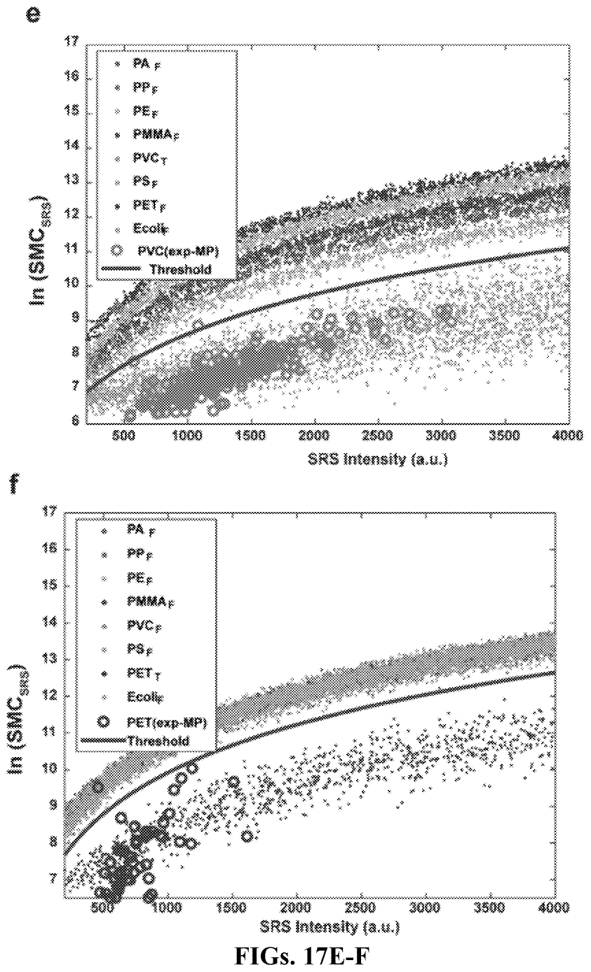

Applying the same model for all standards in the library, we generated a synthetic data set containing the possible SRS spectra for nanoplastics of each polymer in the plastic library. A nice separation of the SMCSRS value appears between the spectra of particle X (X=R, R is the correct identity of standard polymer) and spectra of particle X (X≠R) in all scatter plots (FIG. 17). With the massively generated synthetic data points, a logarithmic function was fitted according to the trend of the scattered points as the threshold line for polymer identification (Supplementary Note 2, Table S2).

TABLE S2
Threshold condition determined for polymer identification

| | | | | Minimum |
|---|---|---|---|---|
| Plastics | | | | Intensity |
| polymer | a | b | c | (a.u.) |
| PA | 2.39493828359969 | −8.84510720757748 | −526.399223635400 | 200 |
| PP | 2.44961340422964 | −9.35922153090780 | −544.0442436072430 | 200 |
| PE | 2.12960918950470 | −5.98617382548675 | −260.292871332060 | 200 |
| PMMA | 2.15491387069439 | −6.04211379746063 | −310.263017959368 | 200 |
| PVC | 2.29359461274251 | −8.20796628579386 | −532.177529823619 | 200 |
| PS | 2.14297210667609 | −6.12510016496094 | −343.305676145489 | 200 |
| PET | 2.24627056905323 | −6.12616605713827 | −265.672011592878 | 200 |

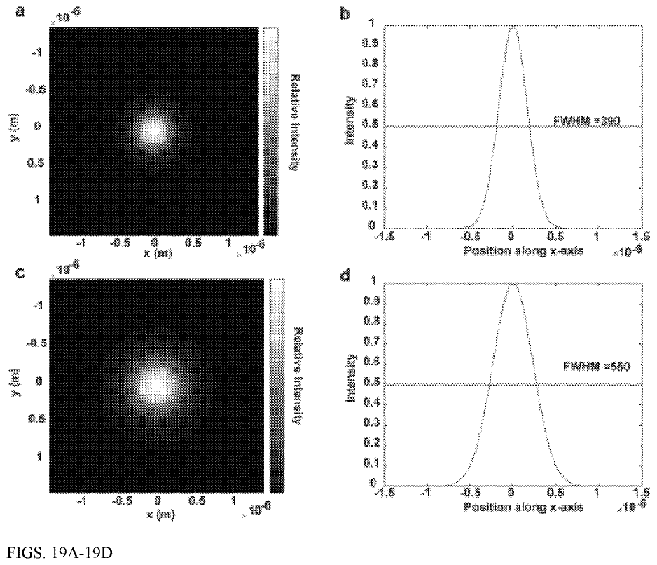

We first evaluate the identification performance by simulating another synthetic data set from all standards in the library. Compared with conventional spectral matching algorithms, the SRS-tailored developed shows minimal false positives in plastic identification (FIG. 18). No more than 0.5% of nonplastic spectra (simulated from E. coli) is misidentified as a hit for any plastic types in the library (FIG. 18C), which is a drastic improvement from over 97% using conventional spectral matching algorithms (FIG. 19A,C). False positive between polymers of similar SRS spectrum is also much reduced with the maximum to be around 5% PA misidentified as PP (FIG. 18C). The same number is also as high as over 97% if PC or SEC are used as similarity measurements with the determined thresholds (FIG. 18A, B).

To further address the possible rare cases when a particle is identified as hits for more than one polymer in the library, the chemical identity of the corresponding particle will be assigned to the polymer with the smallest SMCSRS value. With the established spectral identification workflow, an over 96% identification rate can be achieved with a false positive rate below 1% for all polymers in the library (FIG. 18D). Since PS nanosphere was the only available nanoplastic standard, the experimental validation of the workflow is based on the imaging of the corresponding microplastics prepared from grinding the polymer standards with the cryo-mill. Hoping to mimic a similar level of spectral variation to the best extent, the imaging condition is adjusted accordingly to match the signal-to-noise ratio of nanoplastic measurement. Finally, we confirmed the same identification rate of over 96% in the experimental particle measurement with no observed plastic particles misidentified as other polymers within the library.

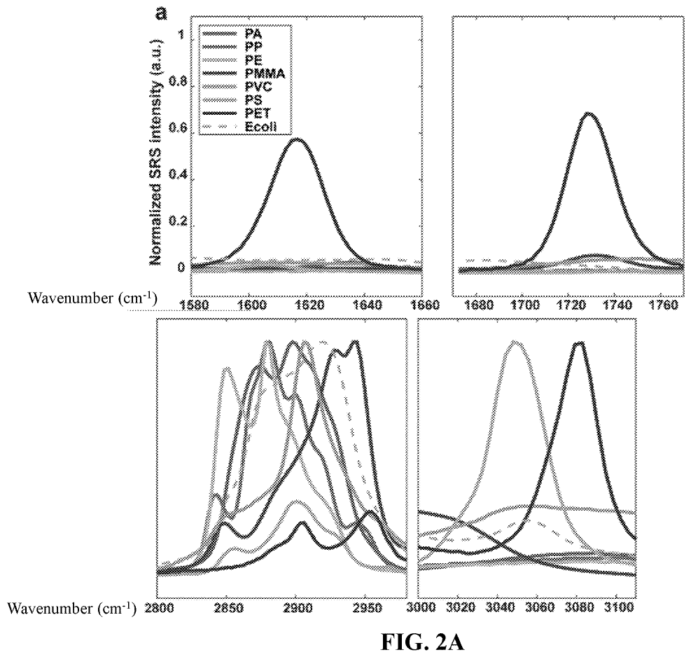

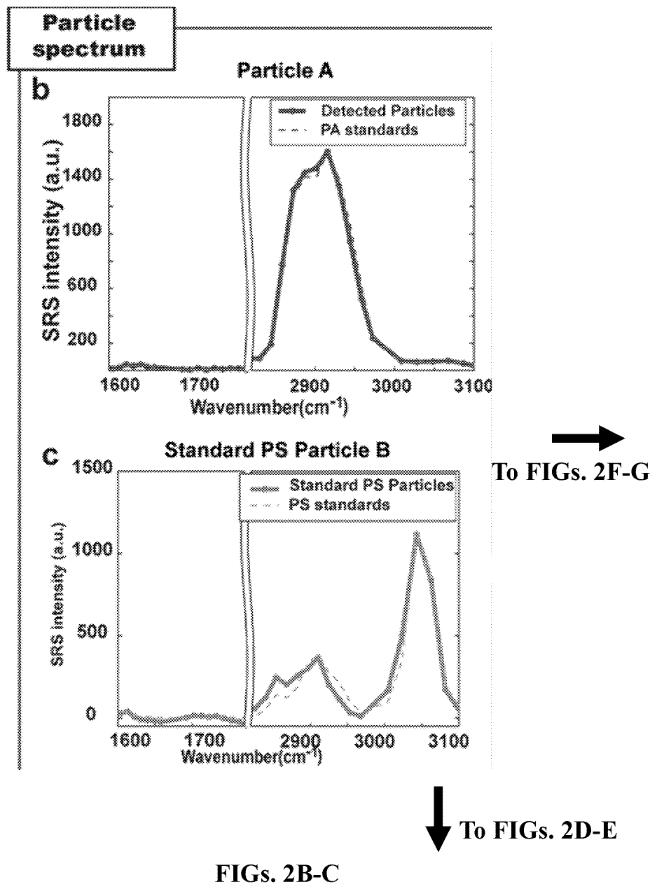

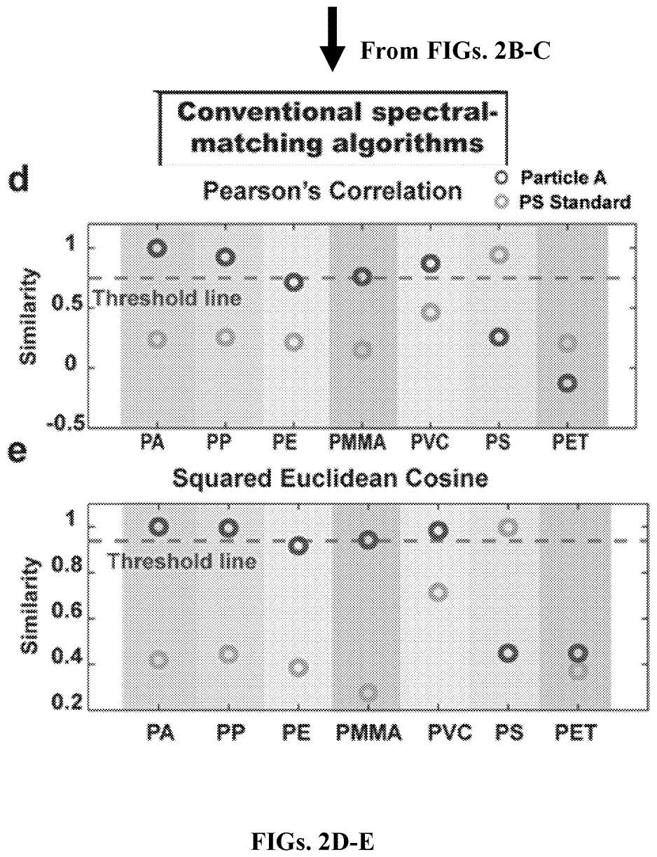

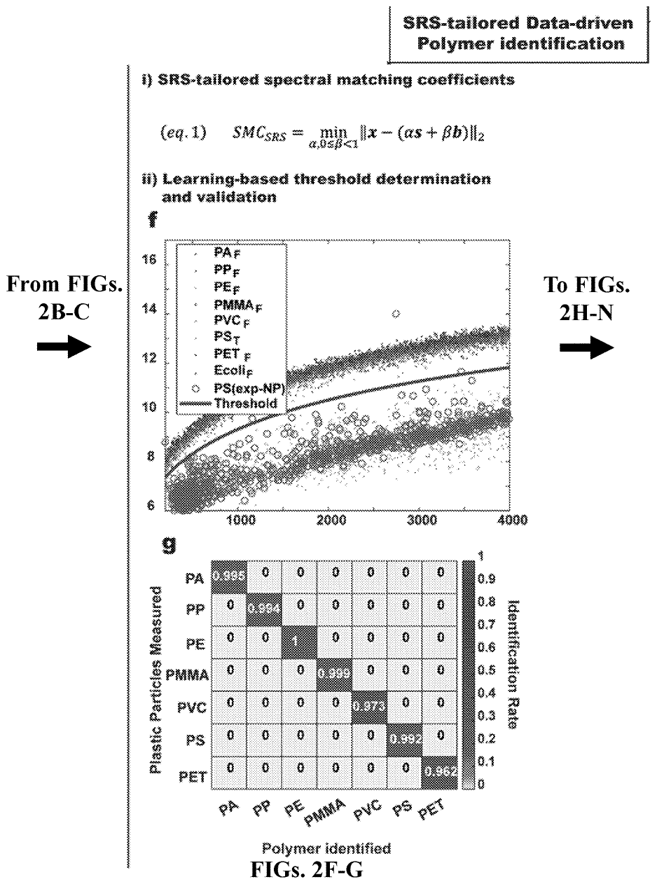

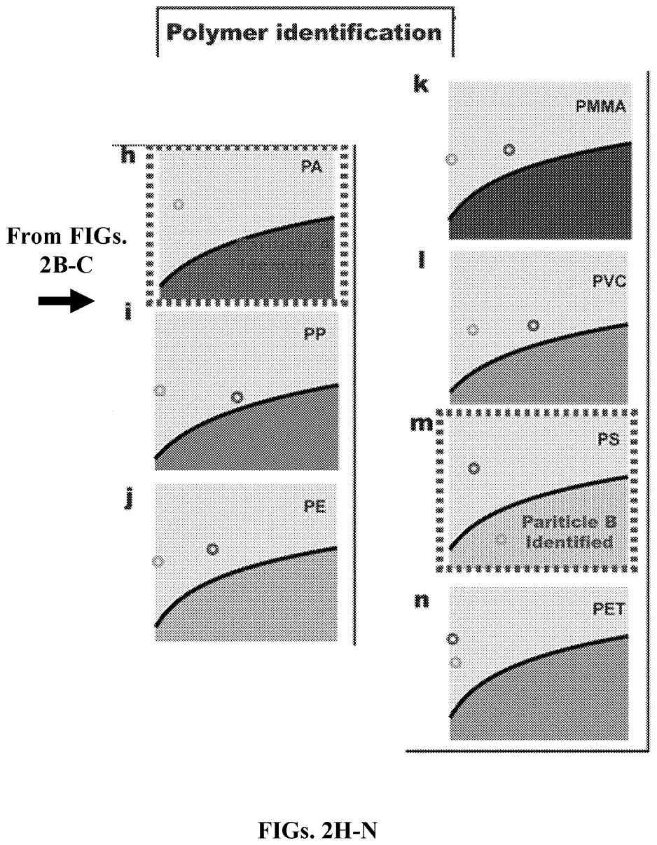

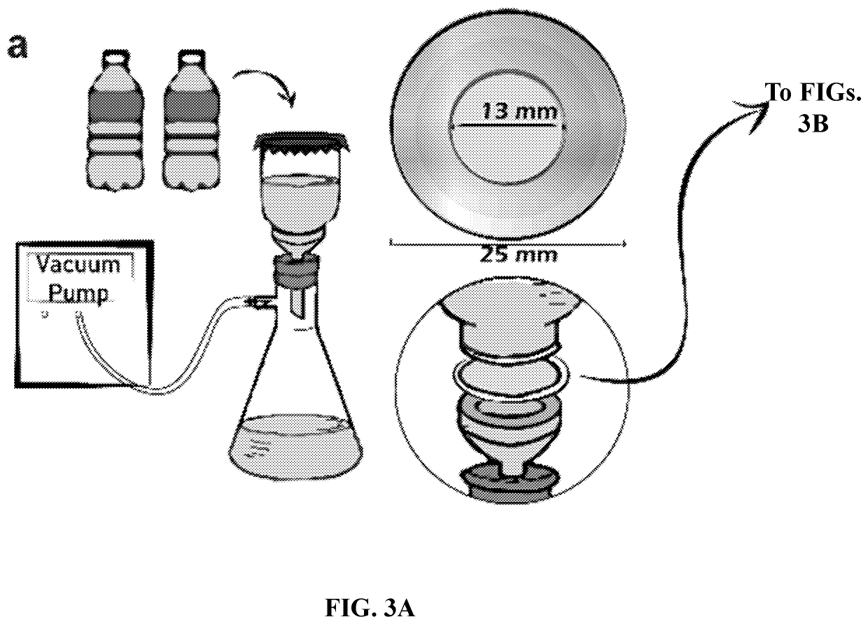

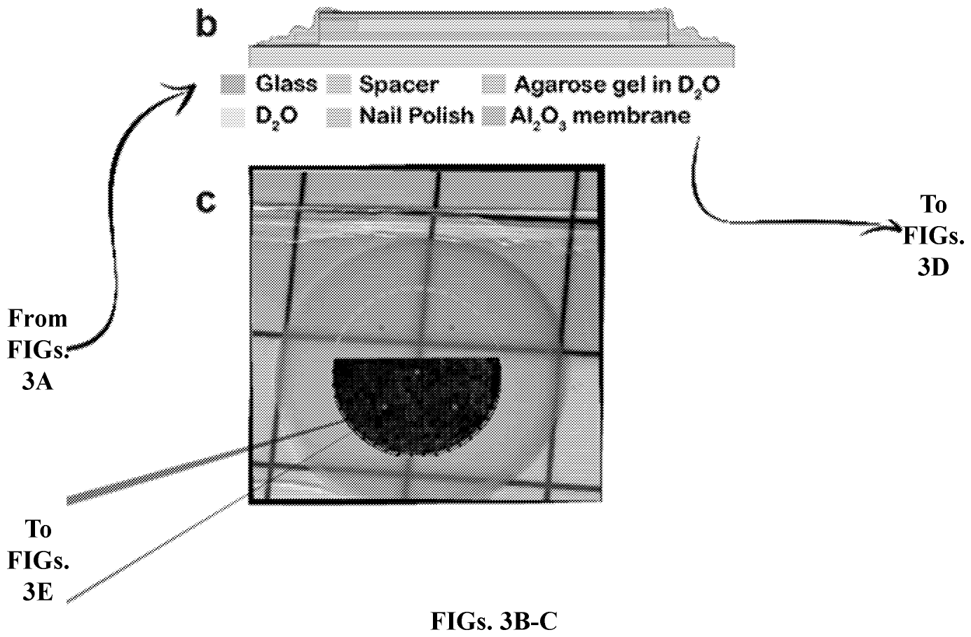

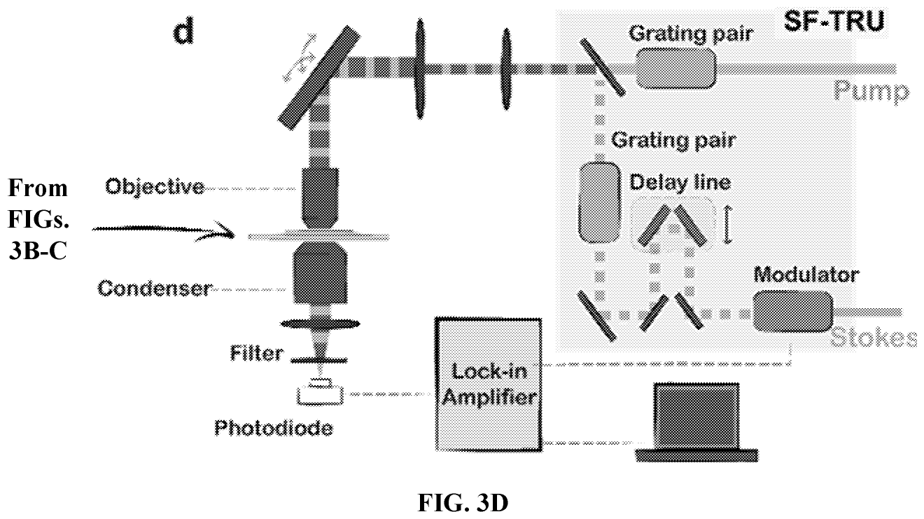

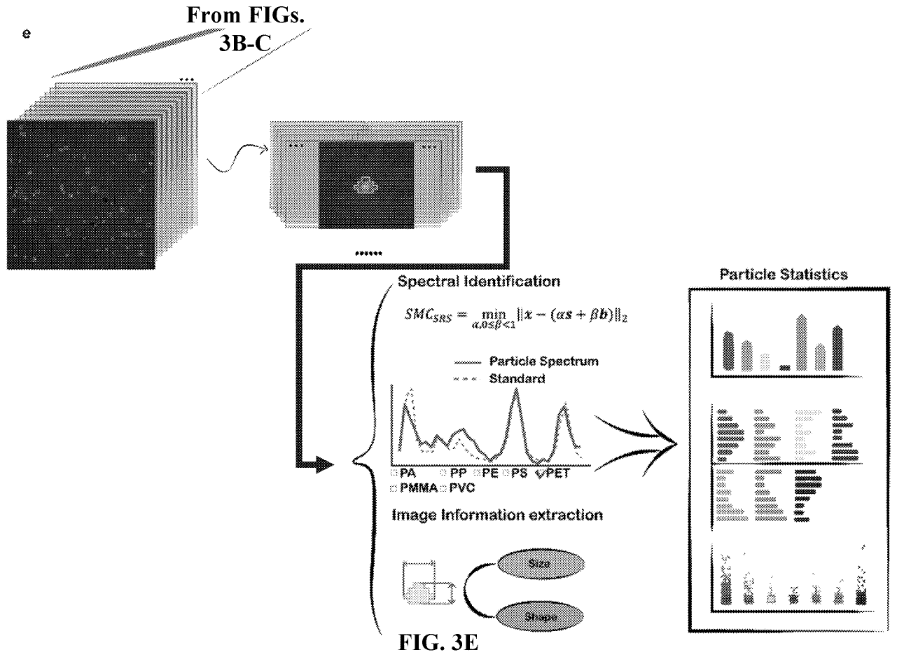

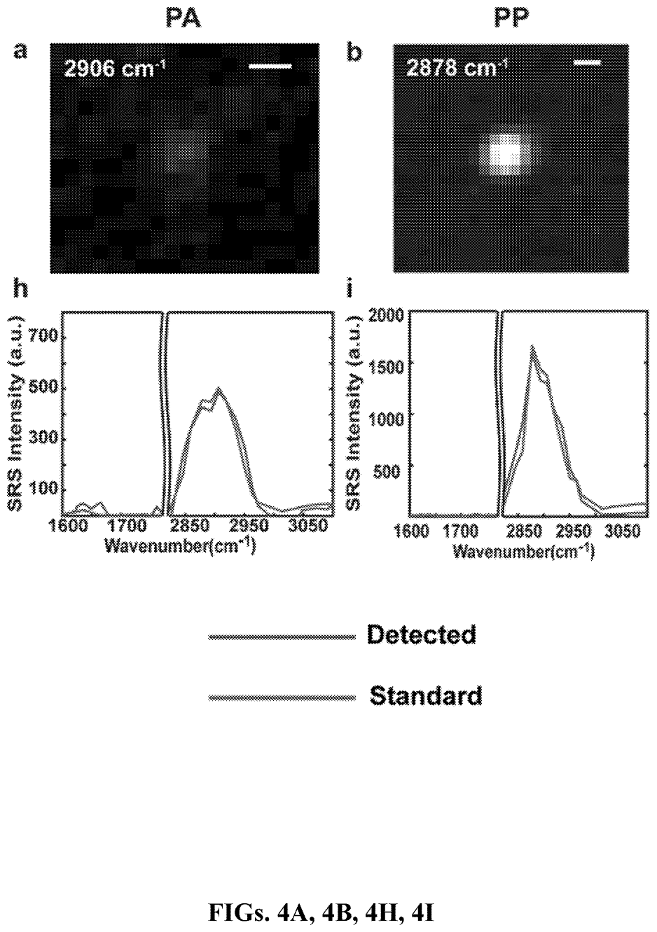

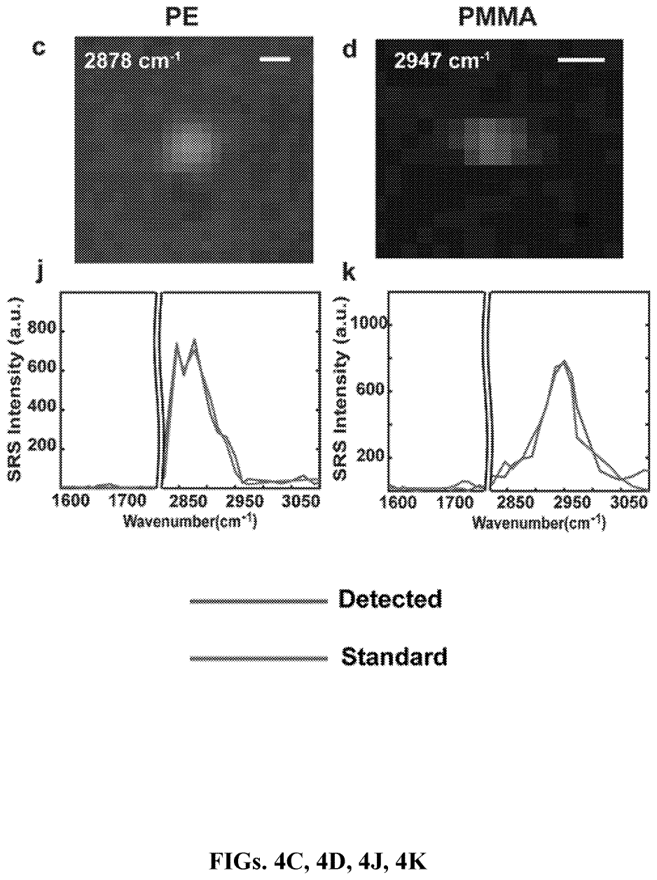

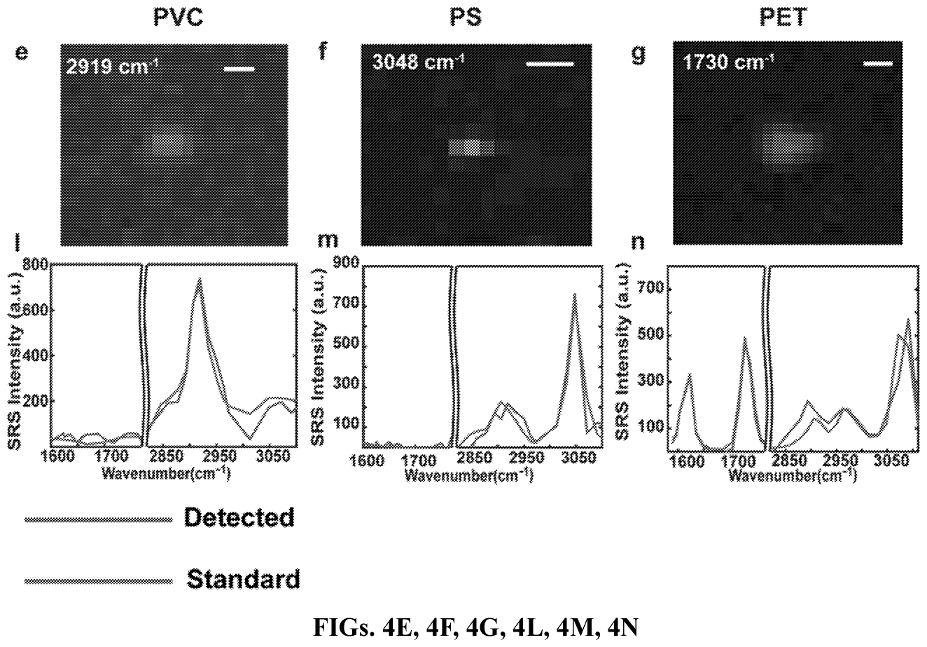

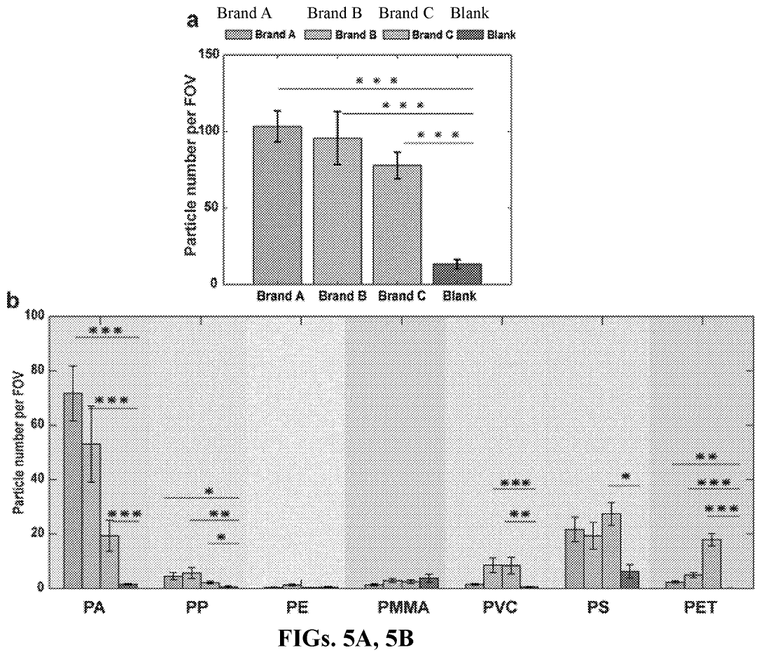

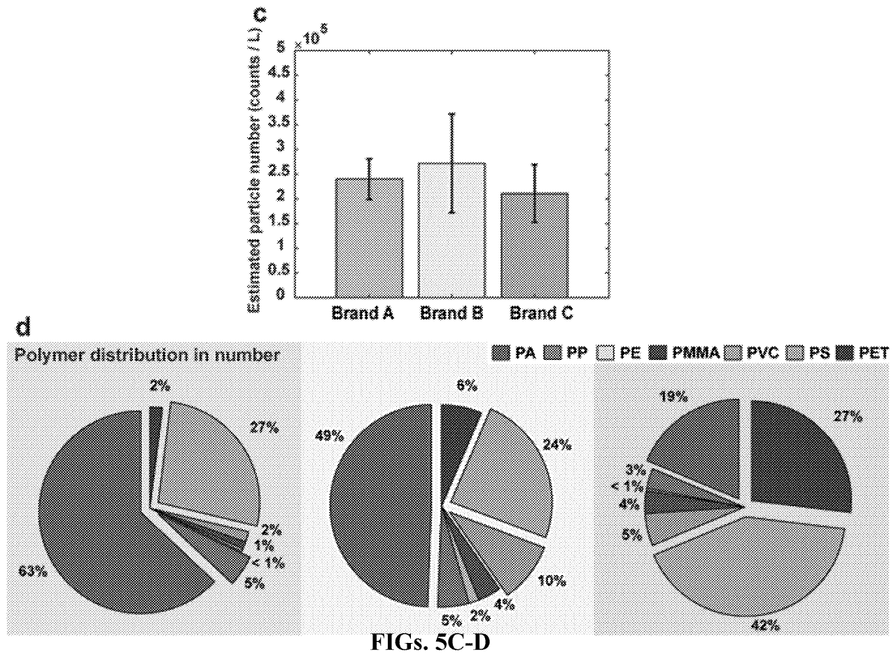

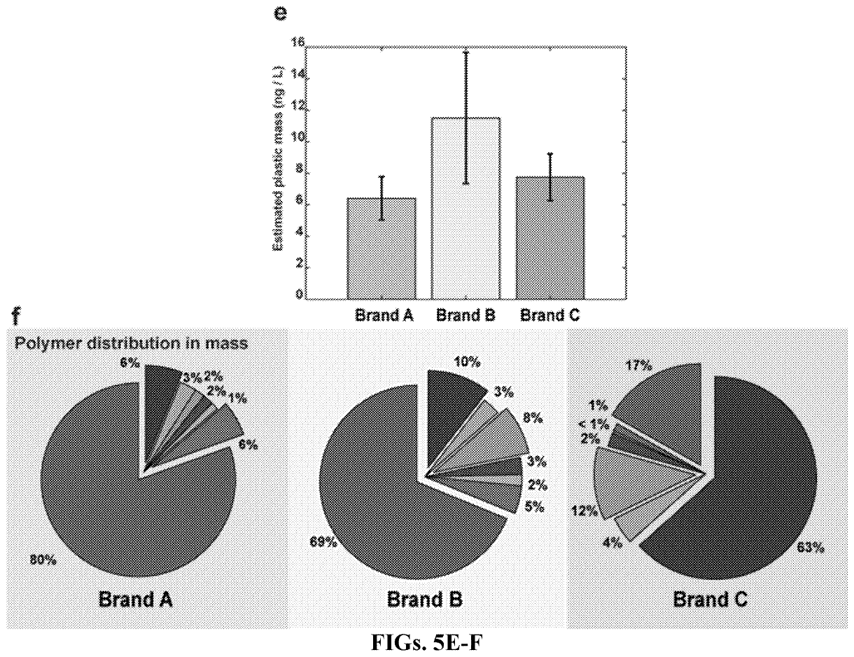

Development of this data-driven algorithm, allows for the identification of each plastic polymer due to the distinct vibrational features within a spectral window restricted by the SRS instrumentation, thus retrieving the required chemical specificity for automated spectral identification. Revisiting the identification of particle A and standard PS nanosphere B, we can correctly identify both particle A and particle B across the library to be PA and PS (FIGS. 2H-2N), with SMCSRS well captures the shape differences missed by conventional algorithms and threshold learned from the data-driven study. Coupling the mindset from data science with advanced measurement science, we finally overcome the fundamental sensitivity-specificity trade-off for high throughput hyperspectral SRS analysis. Superb nano-sensitivity from narrow-band SRS amplification and chemical specificity with robust chemical identification are simultaneously accomplished to fill the missing void in tools for nanoplastics analysis.

TABLE S3
Relative SRS intensity of plastic
polymer standards compared with PS.

| | | | Relative |
|---|---|---|---|
| | | | intensity |
| Plastics polymer | Chemical bonds | Wavenumber | vs PS (RIP) |
| Polyamide | sp³ C—H vibration | 2897 cm⁻¹ | 0.59 |
| Nylon 66 | | | |
| (PA) | | | |
| Polypropylene | sp³ C—H vibration | 2881 cm⁻¹ | 0.94 |
| (PP) | | | |
| Polyethylene | sp³ C—H vibration | 2851 cm⁻¹ | 0.91 |
| (PE) | | | |
| Poly(methyl | sp³ C—H vibration | 2941 cm⁻¹ | 0.45 |
| methacrylate) | | | |
| (PMMA) | | | |
| Polyvinyl chloride | sp³ C—H vibration | 2933 cm⁻¹ | 0.32 |
| (PVC) | | | |
| Polystyrene | sp² C—H vibration | 3050 cm⁻¹ | 1 |
| (PS) | | | |
| Polyethylene | C═O vibration | 1728 cm⁻¹ | 0.42 |
| terephthalate | | | |
| (PET) | | | |

5. Developing Workflow for Micro-Nano Plastic Detection from Bottled Water

With the platform established, we moved on to apply the utility to study micro-nano plastics from real-life samples. Microplastics have been widely found in human foods[57-58], drinks[59], and product packaging[24, 60-62], among which bottled water is of particular interest for being an important source of microplastics to be ingested in daily life[63-66]. Limited by the sensitivity-specificity trade-off of analytical science, the literature knowledge is constrained to microplastics in bottled water (Table S4)[25, 47, 67-69], leaving the nanoplastics mostly uncharted.

TABLE S4
Particle imaging-based micro-nano plastic analytical
techniques on sensitivity, specificity, and throughput
for particle-based quantification.

| | | Detecting | | Abundance | Identification |
|---|---|---|---|---|---|
| Year | Technique | sizes | | (counts/L) | rate |
| 2018 | micro-Raman | ≥1 | μm | (2.6-6.3) × | Not |
| | spectroscopy | | | 10³ | disclosed |
| 2018 | Nile Red staining + | >100 | μm | 0-253 | 20% |
| | Fourier-transform | | | | |
| | infrared | | | | |
| | microscopy (FTIR) | | | | |
| | Nile Red staining * | 6.5-100 | μm | (0-10.3) × | Not apply |
| | | | | 10³ | |
| 2018 | micro-Raman | ≥3 | μm | 14-118 | 1% |
| | spectroscopy | | | | |
| 2019 | Scanning electron | 1.28-4.2 | μm | (3.2-11) × | Not apply |
| | microscopy with | | | 10⁷ | |
| | energy dispersive | | | | |
| | X-Ray analysis | | | | |
| | (SEM-EDX)* | | | | |
| 2021 | FTIR | ≥11 | μm | 75-700 | <1% |
| 2021 | Nile Red staining + | ≥3 | μm | 52-140 | 38% |
| | FTIR + Raman | | | | |

So far, only ensemble characterizations are reported with no information addressing the intrinsic heterogeneity at single particle level. Moreover, the reported workflow requires concentrating plastic nanoparticles from a large volume (16 L) of bottled water with a complicated filtration system to collect enough analytes for necessary chemical and morphological characterization with various ensemble techniques [70]. Here we report a concise workflow for comprehensive micro-nano plastics characterization enabled by rapid single-particle chemical imaging with nano-sensitivity by SRS microscopy. Rich information can be acquired to achieve simultaneous characterization of chemical composition and morphology, enabling multi-dimensional statistics through high-throughput single particle measurement.

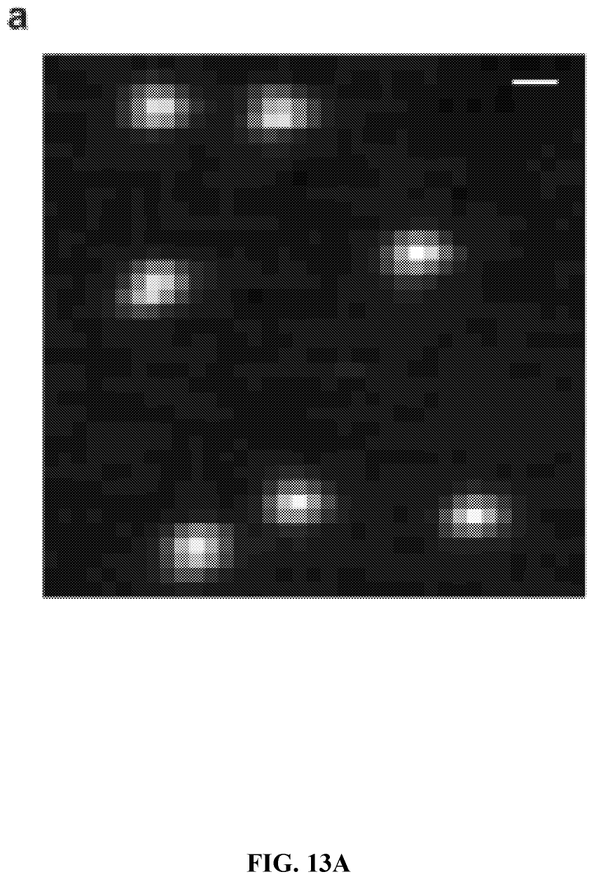

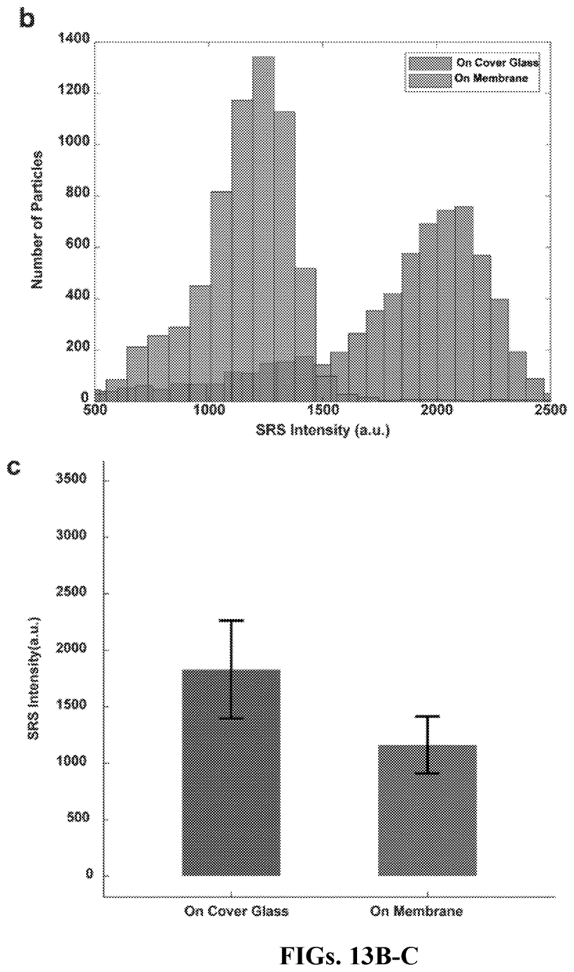

Filtration is one of the most common methods to collect particles above certain sizes onto a membrane surface. It would be highly preferable for analyzing real-world samples if the collected membrane is directly compatible for SRS imaging. Aluminum oxide membranes have minimal background in the target spectral window and have shown good compatibility with vibrational spectroscopy. The seemingly opaque aluminum oxide membrane can be easily transformed into a transparent imaging window by applying heavy water to reduce refractive index mismatch. This resulted in transmissive SRS imaging with acceptable signal retention (~70% of the original sensitivity, FIGS. 13A, 13B). Embedding the particles on the membrane surface in situ with agarose gel prepared with D₂O further enabled stationary SRS imaging of individual particles with minimal imaging background. In this way, a concise sample preprocessing is enough for high-quality SRS imaging of the original filtration membrane (FIG. 13A), avoiding undesirable sample loss or contamination in any complicated sample drying or transferring processes.

The established workflow for analyzing micro-nano plastics exposure from bottled water with hyperspectral SRS imaging is presented in the figures. For each sample, five or more fields of views (FOVs) were randomly sampled within the collecting area for hyperspectral imaging under SRS microscopy. In each FOV, micro-nano plastics were detected by integrated algorithms that automatically performed the particle segmentation and plastic identification with the developed algorithms and validated threshold conditions. Morphological and chemical information of each individual plastic particle obtained from the hyperspectral SRS images was then combined to provide high-dimensional profiling. Following the workflow, we analyzed bottled water from three different brands acquired at the same time from a large retailer. With no access to plastic-free water in the lab (Supplementary Note 6), the Anodisc filters are prepared and measured in the same way as blank control. In the results, we were able to detect individual particles for all 7 plastic polymers in the library unambiguously by spectral matching with their corresponding bulk standards, demonstrating the powerful plastic identification capability of our data-driven hyperspectral SRS imaging platform.

### 6. Multidimensional Profiling of Micro-Nano Plastic in Bottled Water

Quantification from single-particle images with identified plastic polymer composition can inherently provide multi-dimensional information to build the analytical panorama of underexplored nanoplastics in bottled water.

Number quantification through particle counting suggests that, on average, 78-103 plastic particles were identified in each FOV (0.2 mm×0.2 mm) for three different brands, which was significantly higher (p<0.001) than the blank samples. Assuming a uniform distribution of micro-nano plastic particles on the surface of the membrane region, we can make an estimation for the micro-nano plastic exposure from bottled water. We estimate that there are about 2.4±1.3×10⁵ plastic particles ingested from every liter of bottled water measured from different brands. Individual particles of each type of polymer are analyzed separately to reveal chemical heterogeneity. Within the library, PA, PP, PET, PVC, and PS are found likely to play a significant role in micro-nano plastics exposure from bottled water. The exact chemical composition of the micro-nano plastics varied from brand to brand, but PA seem to be the common major contributors in number among all the 3 brands we analyzed.

Harnessing the linear relationship between SRS intensity and the amount of analytes within the focal volume, we are also able to provide an estimation of exposure in mass besides particle number. The mass calibration curve can be estimated for each polymer out of density and relative SRS intensity from the linear relationship obtained by standard PS nanospheres (Supplementary Note 3). Integrated intensity within the region of interest for each particle is thus converted to mass. The estimated micro-nano plastic exposure in mass is calculated to be at the level of around 10 ng/L. Analyzing the chemical composition in mass, we find unneglectable differences between contribution quantified by mass and contribution by number. For example, the PS nanoplastics though dominated in particle number, only account for a minor portion of the mass. Instead, PET becomes the common major contributor together with PA. Such seeming disparity highlights the potential misunderstanding of plastic composition from collective particle characterization, which originated from the heterogeneous nature of micro-nano plastics from real-world samples.

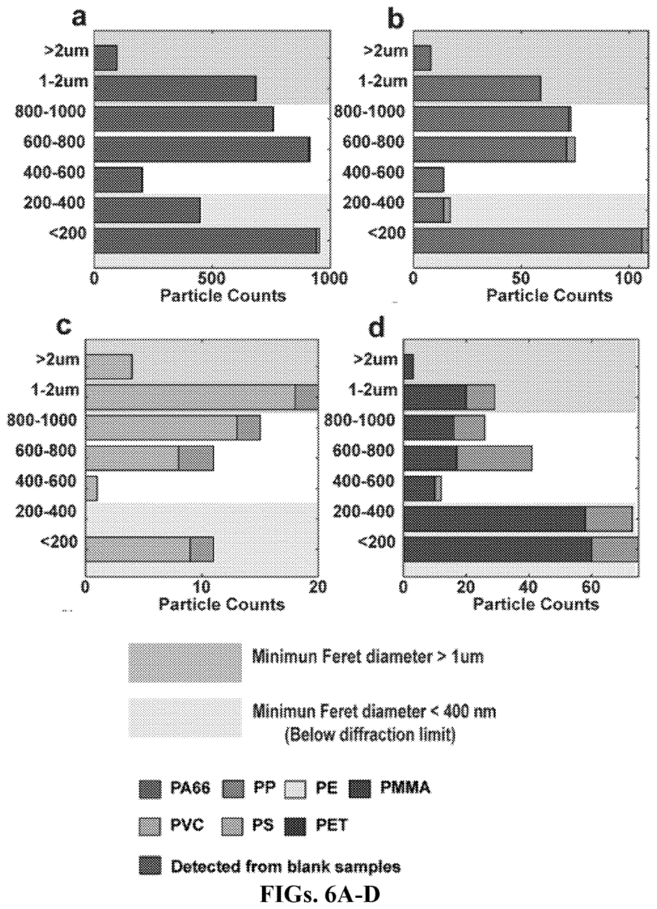

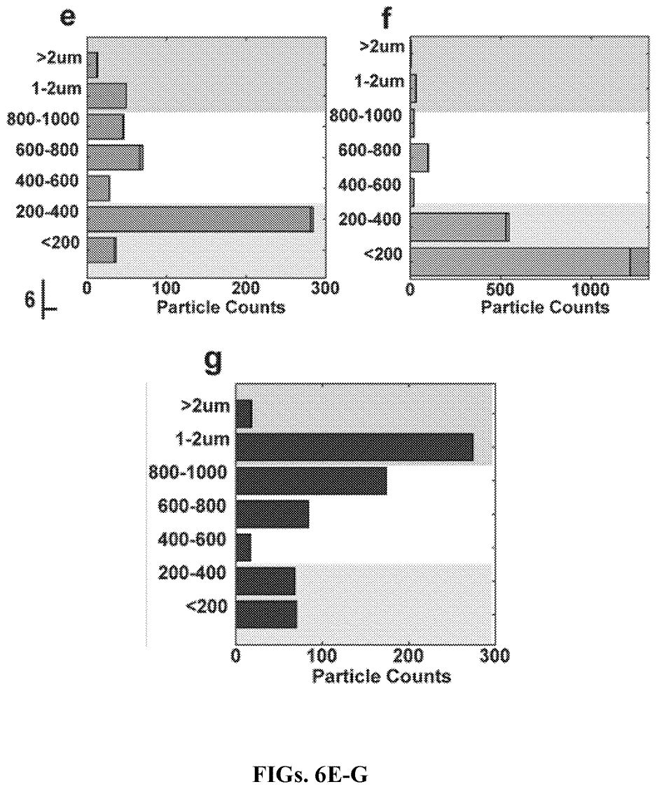

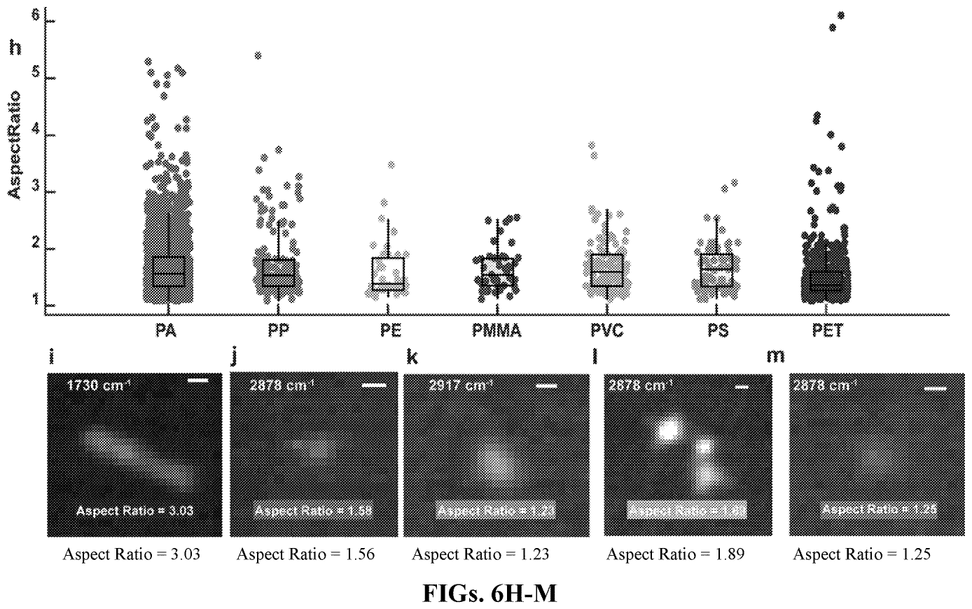

Morphological characterization of individual particles enabled by SRS microscopy directly reveals another dimension of particle heterogeneity. Statistical analysis of particle size and shape from individual micro-nano particles with well-defined identities is reported for the first time. When measuring the size distribution, we are able to characterize particles below the diffraction limit by extrapolating the size from the intensity reading (assuming the particles as solid spheres) and by using the linear relationship between the volume of the particles and SRS signal as calibration (Supplementary Note 3). As a result, we find that plastic particles of different chemical compositions actually have different size distribution patterns (FIGS. 6A-6G). The direct observation of the particle heterogeneity here provides a natural explanation of chemical compositional differences observed from mass or number measurement. Take PS and PET as an example: the size distribution of PS particles centers around 100-200 nm, whereas PET particles tend to have a size distribution that nears 1-2 microns, which explains why PET is a more significant component when measuring in mass while PS clearly dominates when counting the number of particles.

The shape is another important morphological feature that matters as a critical aspect of nanotoxicity. Studies have shown that shape plays a role in determining the cellular uptake of micro-nano particles[71-72]. SRS images of plastic particles confirmed the existence of shape diversity for micro-nano plastics in bottled water. To account for the shape of plastic particles in a statistical manner, we measure the aspect ratio of individual particles above the diffraction limit. Aspect ratio is widely acknowledged in nanotoxicology studies[73-74], and fibrous microplastic particles are commonly identified in environmental samples[75-76]. The aspect ratio of the plastic particles detected ranges from 1 to 6, and the average aspect ratio for particles is around 1.7. The figures provide a pictorial view of how the aspect ratio is related to the particle shape. Particles with an aspect ratio of above 3 are most likely to be fibrous in shape, while particles with an aspect ratio of below 1.4 will be largely spherical. Shape variation on plastic particles has been found in all polymers detected, confirming the widely recognized idea that real-world micro-nano plastics have diverse morphological prosperities. This dimension is hard to be resembled by engineered polymer nanoparticles commonly studied in research laboratories and the toxicological consequences pertaining to real-life plastic particle exposures and their differing physicochemical properties (i.e., size, shape) have yet to be determined.

### 7. Discussions and Conclusions

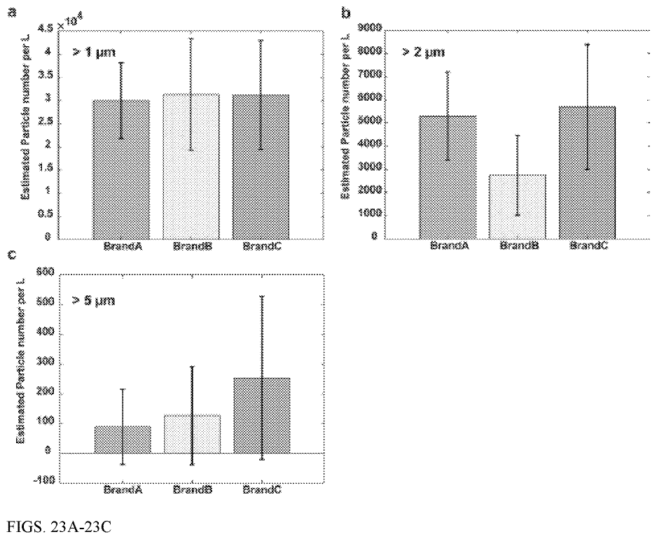

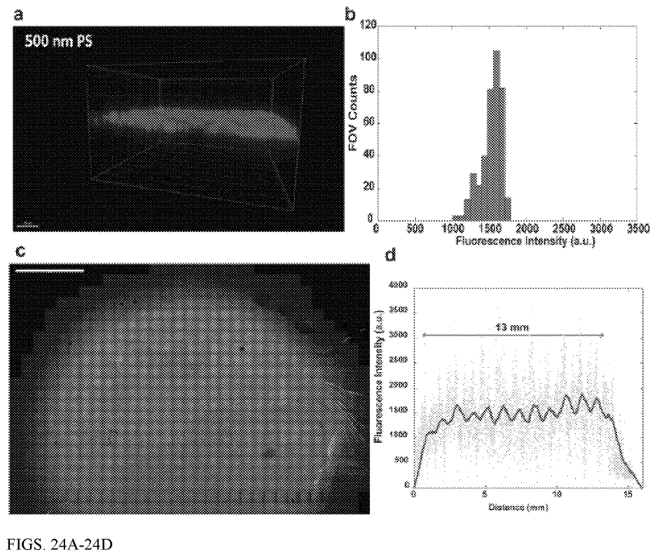

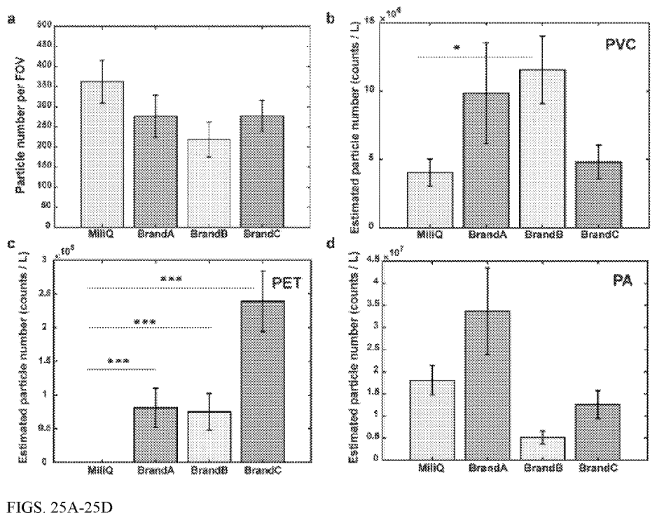

By developing the data-driven hyperspectral SRS imaging platform for micro-nano plastic analysis, we describe a novel methodology to improve nanoparticle detection sensitivity and polymer identification specificity, which has allowed us to start to address the long-lasting knowledge gap of nanoplastics. We estimate that the exposure to the micro-nano plastics from regular bottled water was at the level of 10⁵ particles per liter, which is two to three orders of magnitude more than the previously reported results merely focusing on microplastics (Table S4)[65-66, 68, 77-78]. As it pertains to the estimation of human exposure, these values are substantially higher than those currently reported in the literature[63, 79]. We attribute these differences to the tiny nanoplastic fraction of plastic particulate, which has remained invisible to conventional imaging, but in fact, dominates in number and accounts for ~90% of the entire population of plastic particles detected. The remaining 10% identified as microplastics have a concentration of around 3×10⁴ particles per liter (FIG. 23), with the majority of them in the size below 2 μm. Larger particles (>2 μm), which are easier to identify under regular optical microscopy, are in the same order of magnitude as the reported microplastic analysis depending on the detection limited reported based on different technologies ((FIG. 23, Table S4). Our results confirm the plastic fragmentation beyond the micron level by detecting nanoplastics. Similar to many other particle size distributions in the natural world, there are substantially more nanoplastics, despite being invisible or unidentified under conventional particle imaging techniques, than previously counted micron ones. This population of nanoplastics can be easily overlooked in mass quantification as well since nanoparticles with smaller sizes contain cubic-less substances. However, given the capability of these nanoplastic particles to cross the biological barrier, nanoparticles, despite the seemingly trivial contribution to the mass measurement, play a predominant role in terms of toxicity evaluation[80-81].

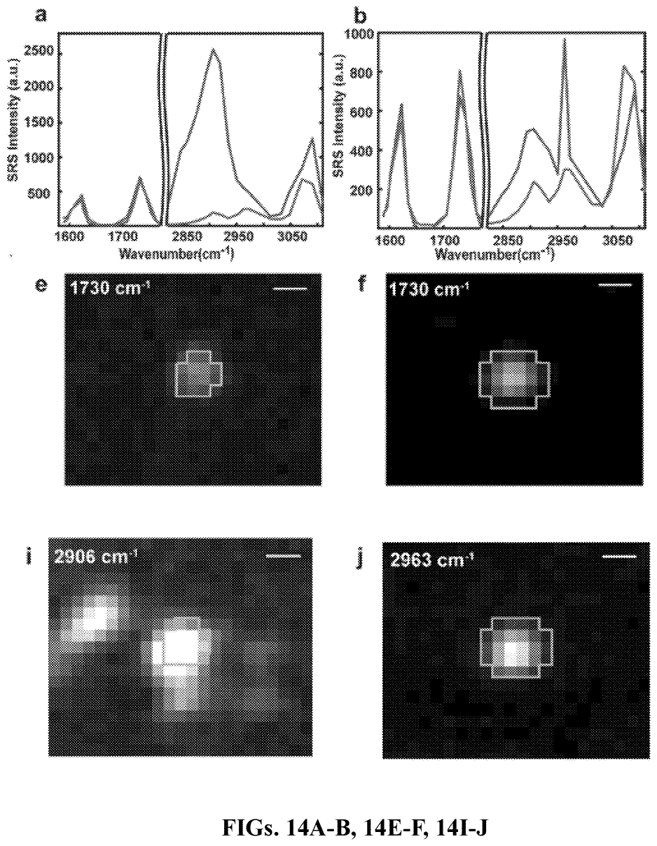

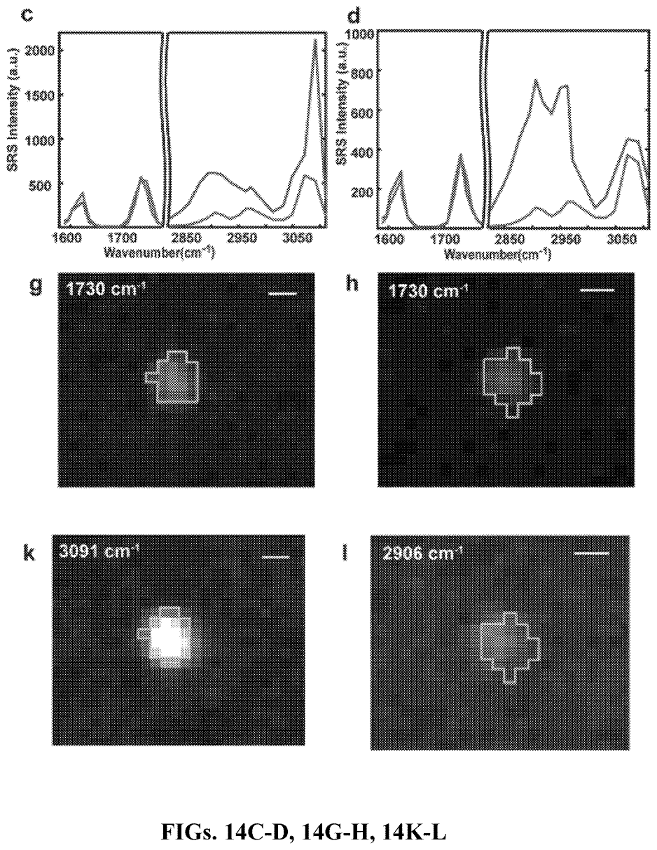

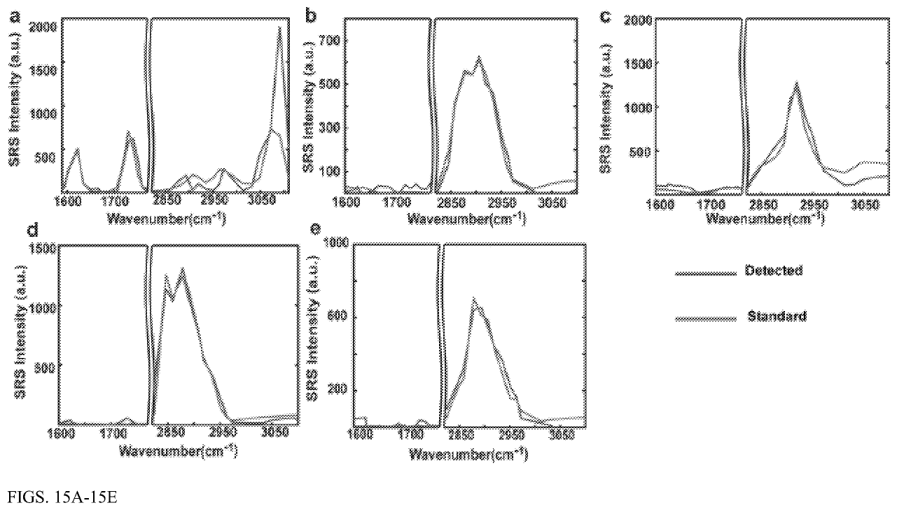

We also find many detected particles present SRS spectra that do not match any of the standards. In fact, our small library of 7 plastic polymers can only account for roughly about 10% of the total particles found under SRS microscopy. A similar level of identification rate is reported in the microplastic analysis in bottled water using vibrational microscopy, indicating the complicated particle composition inside the seemingly simple water sample (Table S4). In this sense, if we assume all organic particles originate from plastics (the same assumption entailed by the quantitative result from SEM-EDX or Nile Red staining[25, 82]), the micro-nano plastic concentration could be as high as 106 particles per liter. However, the common existence of natural organic matter certainly requires prudent distinction from spectroscopy with polymer specificity. Moreover, careful investigation of unidentified particles suggests other aspects that further increase the complexity of identifying chemical composition. For example, some particles exhibit identical features to the characteristic two peaks (C—O ester bond: 1730 cm⁻¹; C═C double bond: 1615 cm⁻¹) of the PET in the fingerprint region but present a great variety of vibrational peaks in the high-frequency C—H region (FIGS. 14A-14D). It is unlikely for a polymer material distinct from PET to display both the C═O and C═C vibrational signatures that perfectly match the standard PET spectrum. A more plausible explanation is that they are small heteroaggregates containing PET and other components, with their SRS spectrum being the superposition of the spectrum from each component. Indeed, for some larger ones, we can even capture the spatial chemical heterogeneity within the aggregates (FIGS. 14A, E, I). The possible formation of heteroaggregates between nanoplastics or other natural organic matter has long been recognized as a potential challenge in the analysis of nanoplastics and may influence toxicological outcomes within a biological exposure12. Direct visualization of such heteroaggregates here in real-world samples supports such concerns. For other possible heteroaggregates formed without PET, rigorous identification will require expanding the spectral library and advancing analytical algorithms for SRS microscopy or other vibrational imaging techniques with extended spectral windows to address challenges imposed by massive particle heterogeneity[35, 83-84].

Another important insight is that the particle size distribution varies with the different chemical compositions, suggesting an interconnection between particle morphology and chemical composition. The observed nonorthogonality between plastic composition and particle morphologies challenges the conventional assumption for micro-nano plastics characterization from ensemble measurement. Take the result from brand C analysis as an example, ensemble measurement of micro-nano plastics might suggest that the major substance is PET from compositional analysis and most of the plastic particles have sizes below 500 nm from the morphological analysis. Assuming the two dimensions as being independent properties, people might have an impression that most of the plastic particles in the bottled water from brand C should be PET particles with a size below 500 nm. However, our result from single particle analysis presents a clear disparity: the sample turns out to contain a small number of PET particles of about micron size and a large number of PS particles with size below 500 nm.

In addition, such nonorthogonality might provide valuable information to understand, trace, and eventually prevent possible sources of micro-nano plastic contamination. Specifically in drinking water production, plastic contamination is confirmed in every step from the well to the bottle[85]. The discovered size differences among different plastic polymers might indicate precious information about contamination sources during water production. For example, PET and PE, which are used as the packaging material for bottled water for all three brands we analyzed, have similar size distribution patterns, with a major population of micron sizes compared to other polymers. A possible explanation is that some particles of this kind are newly released from the bottle package during transportation or storage, which are retained faithfully in the water sample. Whereas, other polymers such as PA, PP, PS, and PVC, which are not the packaging material but also identified with significant numbers, are most likely introduced before or during water production. PP and PA, which share the same broad distribution of sizes, are widely used as equipment components or coagulant aids in water treatment[86]. Particularly, PA is the most popular membrane material used in reverse osmosis[87], which is a common water purification method shared by all three brands. PVC and PS, which have a unique size distribution favoring small nanoplastics, might indicate a contamination source even earlier. PVC is identified to be the most abundant polymer type in raw water from microplastic analysis[85]. PS is known to be used as backbone material for ion exchange resins in water purification[88]. It is possible large particles of PVC or PS get removed by the RO membranes in the later step of the water treatment, leaving mostly nano populations.

Lastly, the interconnection between particle morphology and chemical composition have profound implications for toxicological concerns. As studies with engineered nanoparticles have suggested and investigations of plastic particles are starting to indicate, toxicity induced by micro-nano particles is not only dose-dependent but also related to particle physicochemical characteristics and their effect on cellular interactions and uptake[89-90]. In the case of bottled water from brand C, the cytotoxicity induced by PS nanoplastics plus a small number of PET microplastics would be presumably different from the effect assumed from PET nanoparticles. True comprehensive toxicity evaluation for micro-nano plastics would require multidimensional characterization of plastic particles and the integration of each individual plastic particle regarding their divergent properties on chemical composition and particle morphologies. Single-particle imaging with nanoparticle sensitivity and plastic specificity provides indispensable information to address the rising toxicity concern. Not only it enables plastic particle profiling with accurate exposure quantification, but also it has a unique potential to directly visualize the particle-biology interactions. Therefore, we envision the data-driven hyperspectral SRS imaging platform will continue bridging the gap of knowledge on plastic pollution at the nano level with an expanded spectral library to study more complicated biological and environmental samples.

### Hyperspectral SRS Microscopy

Hyperspectral stimulated Raman scattering microscopy is constructed by sending a dual-output femtosecond laser system (InSight X3, Spectra-Physics) through a commercial Spectral Focusing Timing and Recombination Unit (SF-TRU, Newport Corporation) and coupled into a multiphoton laser scanning microscope (FVMPE-RS, Olympus). The pump beam is tunable in the range of 680-1300 nm, while the Stokes beam is fixed at 1045 nm. Inside SF-TRU, the Stokes beam passes through a resonant electro-optic amplitude modulator (EOM), which modulates the Stokes beam at a 10 MHz resonant frequency. A motorized delay stage (DL125, Newport) is inserted on the Stokes path to adjust the temporal overlap between two beams. A separate grating pair is installed in each beam path for spectral focusing. The pulse width for the pump and the Stokes are calculated to be 4 ps and 3.5 ps, respectively. The existence of grating pairs also reduces the pump tuning range to 790-910 nm (corresponding to a Raman shift range of 1300-3100 cm⁻¹). The two synchronized beams are spatiotemporally overlapped and then coupled into the microscope for SRS imaging. A 25× water objective (XLPlan N, N.A. 1.05, MP, Olympus) is used with a high N.A. condenser lens (oil immersion, N.A. 1.4, Olympus) to collect the pump and stokes beams passing through the samples. A large-area (10 mm×10 mm) Si photodiode (S3590-09, Hamamatsu) is placed after a telescope to detect pump beam intensity loss after filtering out the Stokes beam with two high-optical density band-pass filters (FESH0950, Thorlabs). A 64 V DC power supply is used to reverse-biased the photodiode, and the output current of the detector is electronically prefiltered by a band-pass filter (Mini-Circuits, 9.5-11.5 MHz, 50 (2) before being sent to a fast lock-in amplifier (HF2LI, 50 MHz, Zurich Instruments) with 50 (2 termination for signal demodulation. The in-phase X-output of the lock-in amplifier is fed back into the analog interface box of the microscope to form SRS images. The fast acquisition of the SRS spectrum in each window is achieved by simply adjusting the arrival time of the Stokes beam through a motorized delay stage inside SF-TRU. The delay stage position was calibrated to wavenumber by comparing hyperspectral SRS spectra with spontaneous Raman spectra for polymer standards. Proper calibration is important for consistent matching of the spectrum throughout time. The detailed imaging conditions for different experiments are listed below. All the power is determined after the objective. Unless otherwise mentioned, all SRS images of nanoparticles are acquired with a pixel size of 199 nm.

In the measurement of standard polystyrene (PS) to determine the sensitivity, the central wavelength of the pump beam was 793 nm. Pump power of 120 mW and Stokes power of 214 mW were used for nanosphere measurement and the pixel dwell time settings were in a range of 2 μs-3×8 μs, with a corresponding time constant from lock-in amplifier to be 2 μs-6 μs. Lower power (Ppump=60 mW, PStokes=129 mW) was used for PS microsphere measurement to avoid burning of the particles with a pixel dwell time and time constant of 2 μs, and their AI/I ratios were converted to the same power condition of the PS nanosphere imaging using the linear relationship of the beam power and SRS signal. The noise threshold was determined under the imaging condition for measuring PS nanosphere of 130 nm and 240 nm (Ppump=120 mW, PStokes=214 mW, the pixel dwell time of 8 μs, time constant 6 μs, averaging 3 times). Resolution is measured by imaging 240 nm PS nanosphere under the same condition with a much smaller pixel size of 16 nm.

In the measurement of library spectra, the central wavelengths we used were 793 nm (spectral window: 3000 cm⁻¹-3110 cm⁻¹), 804 nm (spectral window: 2800 cm⁻¹-2980 cm⁻¹), 886 nm (spectral window: 1670 cm⁻¹-1770 cm⁻¹), and 897 nm (spectral window: 1580 cm⁻¹-1660 cm⁻¹), with the stepsize on the delay scanning of 0.02 mm, which corresponds to ~3 cm-1 converting to the unit of wavenumber. The pump power of Ppump=20 mW and Stokes power of PStokes=21-63 mW were used to image micron flakes/fibers of all plastic standards (PE, PP, PA66, PVC, PS, PET, and PMMA), and pump power of Ppump=80 mW and Stokes power of PStokes=171 mW were used for E. coli sample, which represents possible nonplastic material from biological components. The pixel dwell time for all the measurement of the library spectrum were 4 μs with a time constant from the lock-in amplifier of 3 μs. All the FOVs are averaged for each polymer material to obtain the corresponding standard SRS spectra used in the library. When measuring the testing data set, a pixel size of 2 μm is used in microplastic imaging with scaling and pixel dwell time adjusted to mimic the imaging condition for SRS imaging of nanoplastics.

In the measurement of bottled water samples, Ppump=120 mW and PStokes=214 mW were used with a pixel dwell time of 8 μs, time constant of 6 μs, and three times averaging. The central wavelength was the same as the standard measurement with a larger step size of the delay scanning (0.1 mm, ~15 cm⁻¹).

### Sample Preparation of Plastic Standards for SRS Measurement

PS standards of micro-nanospheres in different sizes were bought from Thermo Fisher Invitrogen (0.1 μm: Lot #2170524, 0.2 μm: Lot #2299810, 0.3 μm: Lot #2344121, 0.5 μm: Lot #2230856, 0.7 μm: Lot #2320039, 1 μm Aliphatic Amine latex: batch #2476-HMD-2, 1, 3 μm: Lot #2145532, 10 μm: Lot #2392901). Standard PS micro-nanospheres were diluted 100-1000 times with RO water (Sigma Aldrich, Milli-Q) before being spread and dried on the surface of the coverslip with an imaging spacer (Sigma Aldrich, GBL654008). 1% Agarose gel (thermos scientific, Lot #01162528) was prepared with D2O (Sigma, 151882-100G) at 95° C. 5-10 μL of prepared agarose gel was added before the sample was sandwiched between the glass slide and coverslip for SRS imaging.

Microplastic standards of PET, PP, PE, PVC, and PA66 were obtained from Polymer Kit 1.0 (Hawaii Pacific University). These sub-cm sized plastic pallets were crushed by freeze mill (SPEX SamplePrep 6875D Freezer/Mill Dual Chamber Cryogenic Grinder, 2 rounds for each sample of around 10 pallets, 12 cycles per round with 1 min run time and 1 min cool time at rate 15 CPS per cycle) into powders with irregular particles in micron size. The obtained particles are embedded in the agarose gel described above for SRS imaging.

Another PET standard (GoodFellow, LS567754) used in the spectra library measurement was obtained in fibers with a diameter of 14 microns, which are directly embedded for SRS imaging. PMMA (Sigma Aldrich, 910716, 90875, 73371) and another type of PVC (Sigma Aldrich, 346764), obtained with granules in micron size, are directly embedded for SRS imaging as well. E. coli cells were fixed with 4% PFA and washed three times before being embedded in the gel for SRS imaging as the control standard representing biomass.

### SRS-Tailored Spectral Matching Algorithms and Synthetic Data Generation

The calculation of the SMCSRS employed the Optimization Toolbox implemented in Matlab. An SRS spectrum χ from detected plastic particles could be decomposed according to eq. 1 in FIG. 2. The basic premise was that the plastic particle spectrum s should have the same spectral shape as the corresponding normalized standard spectrum s but with different SRS intensity α depending on the particle size. The contribution from the background βb should also be considered. The background spectrum b was obtained from cropping a particle-free area in the same imaging stack. If the particle size was large enough to fill the focal volume, the contribution from the environmental background β=0; In most cases, particles underfilled the focal volume; thus, the contribution of the background is 0≤β<1. The constrained optimization was then applied to find the corresponding a and B so that the reconstructed spectrum (αs+βb) matched the original particle spectrum as well as possible. Mathematically, the optimized solution was the minimal spectral distance

$${min}_{α , 0 \leq β < 1} {‖ x - ( α s + β b ) ‖}_{2} ,$$

denoted as SMCSRS.

In Matlab, the SRS spectra of plastic nanoparticles were synthesized by randomly scaling the normalized standard spectrum s within the range of digital SRS images and applying the estimated noise fluctuation based on our understanding of the instrumentation. Algorithms were developed to mimic the two main noise sources in a typical hyperspectral SRS spectrum. The fundamental noise on the SRS intensity as a shot-noise-limited technique was determined from the intensity distribution of a cropped area in particle images where no particles are detected. A normal distribution was generated based on this intensity distribution and is later applied to the scaled standard spectrum. The possible laser wavelength fluctuation was simulated from the fine-scanned standard spectrum (FIG. 2 a, ~3 cm⁻¹) by resampling the spectrum in a way to include the local fluctuation in a range determined to be 10 cm⁻¹ for our instrumentation.

### Bottled Water Sample Preparation

All the filtration experiments were carried out in a clean lab with fume hood. All glass apparatuses were thoroughly rinsed with chromic acid before filtration to oxidize and remove any organic substances that might cause possible contamination. Then the precleaned apparatuses were then carefully rinsed with the same brand of bottled water to wash away the acid residue and prepare the apparatus for immediate filtration.

Water samples were filtered through Al₂O₃ membrane filters (Cytiva Whatman, Anodisc 25 mm, 0.2 μm pore-size). A cover made of clean aluminum foil is always applied to the funnel to minimize possible airborne particulate contamination. Only when filling the water analyte, the cover is carefully removed and the funnel is then quickly filled with the water pour directly out of the original water bottle, after the bottled water was thoroughly shaken to resuspend the possible particles inside. For each membrane sample, two entire bottles of commercial purified water (in the same pack acquired from a large retailer) were filtrated to avoid possible errors introduced by non-uniform subsampling of water analyte within one bottle. After the filtration was finished, the filter was carefully placed in a clean glass petri dish and moved to another room, where the filter was quickly mounted to a coverslip with the upper surface sealed by a trimmed imaging spacer and 1% Agarose gel in 90 μL D₂O. The covered sample was then stored at room temperature in a sealed petri dish with enough D₂O to keep the sample humid by soaking the bottom side of the membrane in the D₂O. Before SRS imaging, the covered sample was mounted on a glass slide, on top of which about 80 μL of D₂O is added to fill the gap between the membrane and the glass slide. Then the excess D₂O on the periphery was wiped out before the application of nail polish on all sides of the coverslip to seal the sample and secure it on the glass slide for hyperspectral SRS imaging. The blank samples were prepared by sandwiching the Anodisc filter in the same way as the bottled water samples described above.

Automated Micro-Nano Plastic Detection from Hyperspectral SRS Images

The obtained hyperspectral SRS images were first aligned in the ImageJ (Plugins: align_slice, world wide web at imagejdocu.list.lu/plugin/aligning/align_slice/start) to correct possible pixel drifts across spectral points. The registered stack of SRS images and a selected region with no particles cropped as the background was then imported into Matlab for further automated image processing. For each type of plastic, possible particle candidates were segmented as regions of interest at the on-resonance images based on the corresponding standard SRS spectrum. Each segmented region of interest first went through a crude screening to make sure there were SRS peaks in the target spectral window. For each obtained crude particle candidate, SMCSRS was then calculated using the optimization algorithms from the corresponding standard spectrum before the threshold (Supplementary Note 2) was applied to give a final decision for plastic identification. If the particle is identified to be positive for more than one polymer in the library, the particle will be identified as the polymer with the smallest SMCSRS calculation.

### Statistical Analysis

For each bottled water sample, 5-8 fields of view were imaged for each sample. For blank analysis, four fields of view were imaged for each sample. At each field of view, duplicates of 5 samples were made and the average of measures was used to produce reliable quantification statistics. The number of micro-nano particles detected was analyzed using the generalized linear mixed model analysis assuming a Poisson distribution or a negative binomial distribution to account for overdispersion in the count data. The generalized linear mixed models also take into account the correlation between multiple fields of view from the same bottled water sample. Bonferroni correction was used to adjust the significance level of each hypothesis test to control the overall probability of the type I error for multiple hypothesis tests in the statistical conclusions. The value of the adjusted p-values is denoted using *p<0.05, **p<0.01, ***p<0.001. The generalized linear mixed model analyses were conducted using SAS version 9.4 (SAS Institute Inc.)

Supplementary Note 1: Estimation of the number of repetitive units of 100 nm plastic nanoparticles-see Table S1.

Supplementary Note 2: Making a nonarbitrary binary judgment for polymer identification requires a learning process based on a large enough dataset. With only PS nanoparticles available as the model, we first explored the simulation condition with the PS nanoparticles. The noise on SRS intensity and the frequency uncertainty imposed by SRS instrument is proposed to be the two key parameters in our model to simulate possible SRS spectra of plastic nanoparticles from the corresponding polymer standards. The intensity fluctuation can be directly measured from the noise in the acquired SRS images. For each FOV measurement, there might be slight changes in the laser profile and the delay stage position, which can result in fluctuation of the actual frequency excited in each measurement around the preset spectral points. Assuming the exact vibrational energy excited at the moment for each measurement follows a Gaussian distribution, the range of uncertainty is modeled by checking the consistency in SMCSRS calculation from the synthetic spectra and measured spectra of PS nanoparticles. A Gaussian profile with FWHM of 10 cm⁻¹ is utilized to account for the frequency fluctuation in particle measurements according to the best overlaps between the simulated data and the experimental measurement from the PS nanoparticles (FIG. 16).

Then the same parameter is used to generate thousands of datapoints for the learning process to find the thresholds for unambiguous identification of all plastic polymers in the library (Described in the methods and pictured in FIG. 2F, and FIG. 17). The threshold condition is determined by fitting a logarithmic function (a*log(x−c)+b) that enables the best separation between the target polymer and another polymer in the library that has the closest distribution on the scatter plot.

With the threshold determined for identifying polymer type (Table S2), a new set of data with a thousand synthetic data points for each chemical component in the library was generated to evaluate the accuracy of the boundary condition acquired from the learning process. The results after evaluation were summarized in the confusion matrix (FIG. 18). The performance using SRS-tailored Spectral Matching algorithms with the learning-assisted threshold determination is compared with the performance from conventional spectral matching algorithms based on the simulated data set. For conventional spectral matching algorithms commonly used in the library searching with FTIR and spontaneous Raman, Pearson's Correlation (PC) measurement and Squared Euclidean Cosine (SEC) measurement are presented as the typical examples to make the point. With the measured similarity of 1 to indicate perfect matching, a threshold of 0.7 is most widely used in practice to make a call. Here, with a narrower spectral window and fewer vibrational signatures, the similarity measurement from SRS spectra in the library is generally high (FIG. 2D, E). A threshold of 0.7 would create unnecessarily more false positives. We, therefore, optimize the numeric threshold of similarity for SRS spectra matching based on PS nanoparticles, which is the only particle model of nanoplastics available. The threshold is determined to the quartile of PS similarity measurement that ensured a 95% identification rate for PS.

From the confusion matrix, SRS-tailored Spectral Matching algorithms clearly outperform the conventional way of spectral similarity measurement (FIG. 18), with a maximum of only around 5% misidentification rate in the most challenging case. To further resolve the 5% chance of a particle simultaneously identified as two polymer kinds in the library, we introduce another step in the data analysis workflow to screen for particles that have more than one positive call and identify them as the polymer that gives the smallest SMCSRS value. The performance of the entire identification workflow gives over 96% identification rate for all plastic types and less than 1% false positive rate validated by both the simulation data set (FIG. 18) and experimental data set (FIG. 18).

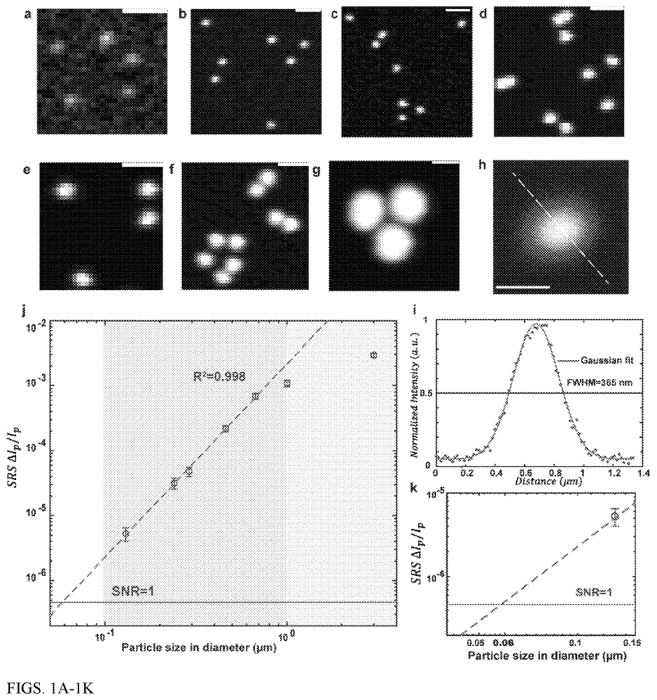

Supplementary Note 3: Quantification analysis using SRS intensity. Good linearity between linear stimulated Raman loss signals (ΔIₚ/Iₚ) and the cubic of particle size (slope of 2.97 for the linear trendline fitted under log-log scale) was shown in FIG. 1J. To better understand the linear dependence of SRS signal amplitude vs particles' volume for sizes, a simulation is done to further verify the experimental measurement.

Assuming an identical Gaussian profile for both pump and Stokes beams at the focal volume, we first identify the individual beam profile to generate a product of the two beam profiles with FWHM of ~400 nm (FIG. 19A, B). The individual beam is found to have an intensity distribution with FWHM of 550 nm (FIG. 19C, D).

Assuming the PS particles are perfect solid spheres with diameters of the given sizes, then we denote the SRS signal of the particle, measured as stimulated Raman loss signals (ΔIₚ/Iₚ) as

$$C \cdot \frac{\int {I}_{p} ( x , y , z ) {I}_{s} ( x , y , z ) S ( x , y , z ) dV}{\int {I}_{p} ( x , y , z ) dV}$$

With Iₚ(x,y,z), Iₛ(x,y,z) is the spatial distribution of the pump and Stokes intensity profile in three dimensions (FHWM: 550 nm in x, y dimensions; 1.5 μm in z dimension). S (x, y, z) maps a 3-dimensional solid sphere with a diameter of the given size at the center of the beam. _% includes all other constant parameters needed to convert the integration results to the expected ΔIₚ/Iₚ which is calculated by dividing the expected SRL for 100 nm PS particles (5×10⁻⁶, detailed estimation process herein) by the integral

$$\frac{\int {I}_{p} ( x , y , z ) {I}_{s} ( x , y , z ) {S}_{100 n m} ( x , y , z ) dV}{\int {I}_{p} ( x , y , z ) dV}$$

Note that in the actual plastic particle imaging experiment, 0.2 μm pixel size is used to enable high throughput imaging. As most of the PS nanoparticles measured have sizes of a few hundred nanometers, the effect on the signal from continuous galvo scanning during the 200 nm step size should not be ignored.

Assuming the galvo continuously scans in the x dimension when measuring particles, the scanning process creates a homogeneous intensity distribution along the x-axis to interact along the particle within this 200 nm sampling step. Taking this into account, we modify the intensity profile (FIG. 20D) and simulated the SRS signal (FIG. 20A-C). Consistent with our experimental measurement, a good linear dependence of SRS signal amplitude vs particles' volume for sizes up to 0.7 microns is observed. Going above 0.7 μm, SRS signal gradually saturates as the particle fills the focal volume. Full saturation is expected for particles with a size above 1.5 μm, where the particle entirely fills the focal volume in all three dimensions.

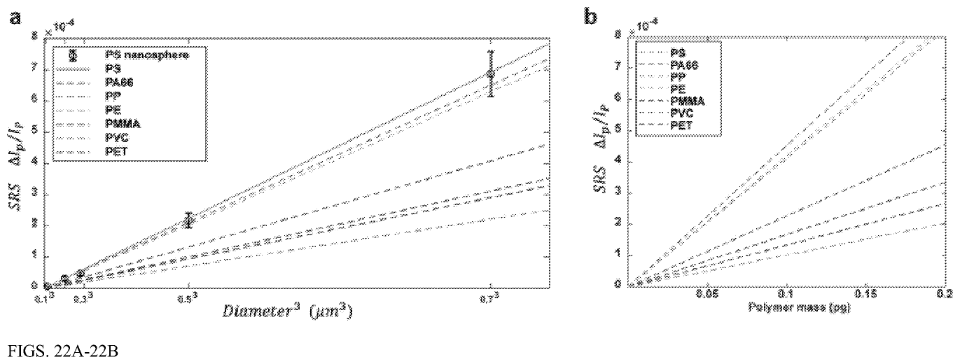

The validated linear dependence of stimulated Raman loss signals (3050 cm⁻¹) on the cubic of particle size in diameter (μm³) can be readily used to estimate the size of PS particles below the diffraction limit. Based on the density of PS polymer from Table S1, the linear dependence of ΔIₚ/Iₚ with cubic of size in diameter (μm³) (FIG. 22A) can then be easily converted to the calibration curve for mass estimation of individual particles (FIG. 22B):

$${k}_{m \_ PS} = \frac{{k}_{0}}{\frac{π}{6} \cdot {ρ}_{PS}}$$

k₀—The linear relationship (y=κ₀χ) of stimulated Raman loss signals with the cubic of particle size in diameter measured from standard PS nanospheres in FIG. 22A.
ρ_{PS}—The density of the PS polymer (Table S1), which is 1.02 g/cm³ used in the calculation.

Note that such linearity fundamentally comes from the linear dependency of SRS signal and the concentration of the target analyte, which in principle, can be applied to other plastic polymers. With no standard nanosphere available for direct measurement, we can quantify the relative intensity of other polymers versus PS polymer (RIP). The calibration curve measured from standard PS nanosphere can be transformed easily to characterize both particle size (FIG. 22A) and mass (FIG. 22B) for other plastic polymers:

$${k}_{X} = {k}_{0} \cdot {RIP}_{X} \\ {k}_{m \_ X}^{′} = \frac{{k}_{X}}{\frac{π}{6} \cdot {ρ}_{X}}$$

RIP_{X}—Relative intensity of polymer X vs PS.
ρₓ—The density of the Polymer X (Table S1).

### REFERENCES

1. Geyer, R.; Jambeck, J. R.; Law, K. L., Production, use, and fate of all plastics ever made. Science advances 2017, 3 (7), e1700782.
2. Thompson, R. C.; Olsen, Y.; Mitchell, R. P.; Davis, A.; Rowland, S. J.; John, A. W.; McGonigle, D.; Russell, A. E., Lost at sea: where is all the plastic? Science 2004, 304 (5672), 838-838.
3. Lim, X., Microplastics are everywhere—but are they harmful? Nature 2021, 593, 22-25.
4. Amato-Lourenço, L. F.; Carvalho-Oliveira, R.; Júnior, G. R.; dos Santos Galvão, L.; Ando, R. A.; Mauad, T., Presence of airborne microplastics in human lung tissue. Journal of Hazardous Materials 2021, 416, 126124.
5. Ragusa, A.; Svelato, A.; Santacroce, C.; Catalano, P.; Notarstefano, V.; Carnevali, O.; Papa, F.; Rongioletti, M. C. A.; Baiocco, F.; Draghi, S., Plasticenta: First evidence of microplastics in human placenta. Environment International 2021, 146, 106274.
6. Wagner, S.; Reemtsma, T., Things we know and don't know about nanoplastic in the environment. Nat Nanotechnol 2019, 14 (4), 300-301.
7. Luo, Y.; Li, L.; Feng, Y.; Li, R.; Yang, J.; Peijnenburg, W. J.; Tu, C., Quantitative tracing of uptake and transport of submicrometre plastics in crop plants using lanthanide chelates as a dual-functional tracer. Nature Nanotechnology 2022, 17 (4), 424-431.
8. Sun, X.-D.; Yuan, X.-Z.; Jia, Y.; Feng, L.-J.; Zhu, F.-P.; Dong, S.-S.; Liu, J.; Kong, X.; Tian, H.; Duan, J.-L., Differentially charged nanoplastics demonstrate distinct accumulation in Arabidopsis thaliana. Nature nanotechnology 2020, 15 (9), 755-760.
9 Mitrano, D. M.; Beltzung, A.; Frehland, S.; Schmiedgruber, M.; Cingolani, A.; Schmidt, F., Synthesis of metal-doped nanoplastics and their utility to investigate fate and behaviour in complex environmental systems. Nature nanotechnology 2019, 14 (4), 362-368.
10. Fournier, S. B.; D'Errico, J. N.; Adler, D. S.; Kollontzi, S.; Goedken, M. J.; Fabris, L.; Yurkow, E. J.; Stapleton, P. A., Nanopolystyrene translocation and fetal deposition after acute lung exposure during late-stage pregnancy. Particle and Fibre Toxicology 2020, 17 (1), 1-11.
11. Mitrano, D. M.; Wick, P.; Nowack, B., Placing nanoplastics in the context of global plastic pollution. Nat Nanotechnol 2021, 16 (5), 491-500.
12. Gigault, J.; El Hadri, H.; Nguyen, B.; Grassl, B.; Rowenczyk, L.; Tufenkji, N.; Feng, S.; Wiesner, M., Nanoplastics are neither microplastics nor engineered nanoparticles. Nat Nanotechnol 2021, 16 (5), 501-507.
13. Mitchell, M. J.; Billingsley, M. M.; Haley, R. M.; Wechsler, M. E.; Peppas, N. A.; Langer, R., Engineering precision nanoparticles for drug delivery. Nature Reviews Drug Discovery 2021, 20 (2), 101-124.
14. Blanco, E.; Shen, H.; Ferrari, M., Principles of nanoparticle design for overcoming biological barriers to drug delivery. Nature biotechnology 2015, 33 (9), 941-951.
15. Behzadi, S.; Serpooshan, V.; Tao, W.; Hamaly, M. A.; Alkawareek, M. Y.; Dreaden, E. C.; Brown, D.; Alkilany, A. M.; Farokhzad, O. C.; Mahmoudi, M., Cellular uptake of nanoparticles: journey inside the cell. Chemical Society Reviews 2017, 46 (14), 4218-4244.
16. Schröter, L.; Ventura, N., Nanoplastic Toxicity: Insights and Challenges from Experimental Model Systems. Small 2022, 18 (31), 2201680.
17. Araujo, C. F.; Nolasco, M. M.; Ribeiro, A. M.; Ribeiro-Claro, P. J., Identification of microplastics using Raman spectroscopy: Latest developments and future prospects. Water research 2018, 142, 426-440.
18. Anger, P. M.; von der Esch, E.; Baumann, T.; Elsner, M.; Niessner, R.; Ivleva, N. P., Raman microspectroscopy as a tool for microplastic particle analysis. TrAC Trends in Analytical Chemistry 2018, 109, 214-226.
19. Ivleva, N. P., Chemical Analysis of Microplastics and Nanoplastics: Challenges, Advanced Methods, and Perspectives. Chem Rev 2021, 121 (19), 11886-11936.
20 Primpke, S.; Wirth, M.; Lorenz, C.; Gerdts, G., Reference database design for the automated analysis of microplastic samples based on Fourier transform infrared (FTIR) spectroscopy. Analytical and bioanalytical chemistry 2018, 410 (21), 5131-5141.
21. Peeken, I.; Primpke, S.; Beyer, B.; Gütermann, J.; Katlein, C.; Krumpen, T.; Bergmann, M.; Hehemann, L.; Gerdts, G., Arctic sea ice is an important temporal sink and means of transport for microplastic. Nature communications 2018, 9 (1), 1-12.
22. Käppler, A.; Fischer, D.; Oberbeckmann, S.; Schernewski, G.; Labrenz, M.; Eichhorn, K.-J.; Voit, B., Analysis of environmental microplastics by vibrational microspectroscopy: FTIR, Raman or both? Analytical and bioanalytical chemistry 2016, 408 (29), 8377-8391.
23. Renner, G.; Schmidt, T. C.; Schram, J., Analytical methodologies for monitoring micro (nano) plastics: which are fit for purpose? Current Opinion in Environmental Science & Health 2018, 1, 55-61.
24. Hernandez, L. M.; Xu, E. G.; Larsson, H. C.; Tahara, R.; Maisuria, V. B.; Tufenkji, N., Plastic teabags release billions of microparticles and nanoparticles into tea. Environmental science & technology 2019, 53 (21), 12300-12310.
25. Zuccarello, P.; Ferrante, M.; Cristaldi, A.; Copat, C.; Grasso, A.; Sangregorio, D.; Fiore, M.; Oliveri Conti, G., Exposure to microplastics (<10 mum) associated to plastic bottles mineral water consumption: The first quantitative study. Water Res 2019, 157, 365-371.
26. Jakubowicz, I.; Enebro, J.; Yarahmadi, N., Challenges in the search for nanoplastics in the environment-A critical review from the polymer science perspective. Polymer Testing 2021, 93.
27. Li, Y.; Wang, Z.; Guan, B., Separation and identification of nanoplastics in tap water. Environ Res 2022, 204 (Pt B), 112134.
28. Foetisch, A.; Filella, M.; Watts, B.; Vinot, L. H.; Bigalke, M., Identification and characterisation of individual nanoplastics by scanning transmission X-ray microscopy (STXM). J Hazard Mater 2022, 426, 127804.
29. Kurouski, D.; Dazzi, A.; Zenobi, R.; Centrone, A., Infrared and Raman chemical imaging and spectroscopy at the nanoscale. Chemical Society Reviews 2020, 49 (11), 3315-3347.
30. C. ten Have, I.; Duijndam, A. J.; Oord, R.; van Berlo-van den Broek, H. J.; Vollmer, I.; Weckhuysen, B. M.; Meirer, F., Photoinduced Force Microscopy as an Efficient Method Towards the Detection of Nanoplastics. Chemistry-Methods 2021, 1 (5), 205-209.
31. Freudiger, C. W.; Min, W.; Saar, B. G.; Lu, S.; Holtom, G. R.; He, C.; Tsai, J. C.; Kang, J. X.; Xie, X. S., Label-free biomedical imaging with high sensitivity by stimulated Raman scattering microscopy. Science 2008, 322 (5909), 1857-1861.
32 Hu, F.; Shi, L.; Min, W., Biological imaging of chemical bonds by stimulated Raman scattering microscopy. Nature methods 2019, 16 (9), 830-842.
33. Cheng, J.-X.; Xie, X. S., Vibrational spectroscopic imaging of living systems: An emerging platform for biology and medicine. Science 2015, 350 (6264), aaa8870.
34. Cheng, J. X.; Min, W.; Ozeki, Y.; (Eds.), D. P., Stimulated Raman Scattering Microscopy: Techniques and Applications. Elsevier: 2021.
35 Camp Jr, C. H.; Cicerone, M. T., Chemically sensitive bioimaging with coherent Raman scattering. Nature photonics 2015, 9 (5), 295-305.
36. Prince, R. C.; Frontiera, R. R.; Potma, E. O., Stimulated Raman scattering: from bulk to nano. Chemical reviews 2017, 117 (7), 5070-5094.
37. Zada, L.; Leslie, H. A.; Vethaak, A. D.; Tinnevelt, G. H.; Jansen, J. J.; de Boer, J. F.; Ariese, F., Fast microplastics identification with stimulated Raman scattering microscopy. Journal of Raman spectroscopy 2018, 49 (7), 1136-1144.
38. Laptenok, S. P.; Martin, C.; Genchi, L.; Duarte, C. M.; Liberale, C., Stimulated Raman microspectroscopy as a new method to classify microfibers from environmental samples. Environ Pollut 2020, 267, 115640.
39. Min, W.; Freudiger, C. W.; Lu, S.; Xie, X. S., Coherent nonlinear optical imaging: beyond fluorescence microscopy. Annual review of physical chemistry 2011, 62, 507.
40. Fu, D.; Holtom, G.; Freudiger, C.; Zhang, X.; Xie, X. S., Hyperspectral imaging with stimulated Raman scattering by chirped femtosecond lasers. The Journal of Physical Chemistry B 2013, 117 (16), 4634-4640.
41. Wei, L.; Min, W., Electronic preresonance stimulated Raman scattering microscopy. The journal of physical chemistry letters 2018, 9 (15), 4294-4301.
42. Li, L.; Luo, Y.; Li, R.; Zhou, Q.; Peijnenburg, W. J.; Yin, N.; Yang, J.; Tu, C.; Zhang, Y., Effective uptake of submicrometre plastics by crop plants via a crack-entry mode. Nature sustainability 2020, 3 (11), 929-937.
43. Shen, M.; Zhang, Y.; Zhu, Y.; Song, B.; Zeng, G.; Hu, D.; Wen, X.; Ren, X., Recent advances in toxicological research of nanoplastics in the environment: A review. Environmental pollution 2019, 252, 511-521.
44. Zeytunyan, A.; Baldacchini, T.; Zadoyan, R. In Module for multiphoton high-resolution hyperspectral imaging and spectroscopy, Multiphoton Microscopy in the Biomedical Sciences XVIII, SPIE: 2018; pp 48-55.
45. Manifold, B.; Figueroa, B.; Fu, D., Hyperspectral SRS imaging via spectral focusing. In Stimulated Raman Scattering Microscopy, Elsevier: 2022; pp 69-79.
46. Xu, J.-L.; Thomas, K. V.; Luo, Z.; Gowen, A. A., FTIR and Raman imaging for microplastics analysis: State of the art, challenges and prospects. TrAC Trends in Analytical Chemistry 2019, 119, 115629.
47. Schymanski, D.; Ossmann, B. E.; Benismail, N.; Boukerma, K.; Dallmann, G.; von der Esch, E.; Fischer, D.; Fischer, F.; Gilliland, D.; Glas, K.; Hofmann, T.; Kappler, A.; Lacorte, S.; Marco, J.; Rakwe, M. E.; Weisser, J.; Witzig, C.; Zumbulte, N.; Ivleva, N. P., Analysis of microplastics in drinking water and other clean water samples with micro-Raman and micro-infrared spectroscopy: minimum requirements and best practice guidelines. Anal Bioanal Chem 2021, 413 (24), 5969-5994.
48. Samuel, A. Z.; Mukojima, R.; Horii, S.; Ando, M.; Egashira, S.; Nakashima, T.; Iwatsuki, M.; Takeyama, H., On selecting a suitable spectral matching method for automated analytical applications of Raman spectroscopy. ACS omega 2021, 6 (3), 2060-2065.
49 Liao, C.-S.; Slipchenko, M. N.; Wang, P.; Li, J.; Lee, S.-Y.; Oglesbee, R. A.; Cheng, J.-X., Microsecond scale vibrational spectroscopic imaging by multiplex stimulated Raman scattering microscopy. Light: Science & Applications 2015, 4 (3), e265-e265.
50. Réhault, J.; Crisafi, F.; Kumar, V.; Ciardi, G.; Marangoni, M.; Cerullo, G.; Polli, D., Broadband stimulated Raman scattering with Fourier-transform detection. Optics express 2015, 23 (19), 25235-25246.
51. Camp Jr, C. H.; Lee, Y. J.; Heddleston, J. M.; Hartshorn, C. M.; Walker, A. R. H.; Rich, J. N.; Lathia, J. D.; Cicerone, M. T., High-speed coherent Raman fingerprint imaging of biological tissues. Nature photonics 2014, 8 (8), 627-634.
52. Chen, R. J.; Lu, M. Y.; Chen, T. Y.; Williamson, D. F.; Mahmood, F., Synthetic data in machine learning for medicine and healthcare. Nature Biomedical Engineering 2021, 5 (6), 493-497.
53. Liu, Z.; Su, W.; Ao, J.; Wang, M.; Jiang, Q.; He, J.; Gao, H.; Lei, S.; Nie, J.; Yan, X., Instant diagnosis of gastroscopic biopsy via deep-learned single-shot femtosecond stimulated Raman histology. Nature communications 2022, 13 (1), 1-12.
54. Hollon, T. C.; Pandian, B.; Adapa, A. R.; Urias, E.; Save, A. V.; Khalsa, S. S. S.; Eichberg, D. G.; D'Amico, R. S.; Farooq, Z. U.; Lewis, S., Near real-time intraoperative brain tumor diagnosis using stimulated Raman histology and deep neural networks. Nature medicine 2020, 26 (1), 52-58.
55. Lin, H.; Lee, H. J.; Tague, N.; Lugagne, J.-B.; Zong, C.; Deng, F.; Shin, J.; Tian, L.; Wong, W.; Dunlop, M. J., Microsecond fingerprint stimulated Raman spectroscopic imaging by ultrafast tuning and spatial-spectral learning. Nature communications 2021, 12 (1), 1-12.
56. Manifold, B.; Men, S.; Hu, R.; Fu, D., A versatile deep learning architecture for classification and label-free prediction of hyperspectral images. Nature machine intelligence 2021, 3 (4), 306-315.
57. Peixoto, D.; Pinheiro, C.; Amorim, J.; Oliva-Teles, L.; Guilhermino, L.; Vieira, M. N., Microplastic pollution in commercial salt for human consumption: A review. Estuarine, Coastal and Shelf Science 2019, 219, 161-168.
58. Liu, Q.; Chen, Z.; Chen, Y.; Yang, F.; Yao, W.; Xie, Y., Microplastics and nanoplastics: emerging contaminants in food. Journal of Agricultural and Food Chemistry 2021, 69 (36), 10450-10468.
59. Vitali, C.; Peters, R.; Janssen, H.-G.; W. F. Nielen, M., Microplastics and nanoplastics in food, water, and beverages; part I. Occurrence. TrAC Trends in Analytical Chemistry 2022.
60. Li, D.; Shi, Y.; Yang, L.; Xiao, L.; Kehoe, D. K.; Gun′ko, Y. K.; Boland, J. J.; Wang, J. J., Microplastic release from the degradation of polypropylene feeding bottles during infant formula preparation. Nature Food 2020, 1 (11), 746-754.
61. Su, Y.; Hu, X.; Tang, H.; Lu, K.; Li, H.; Liu, S.; Xing, B.; Ji, R., Steam disinfection releases micro (nano) plastics from silicone-rubber baby teats as examined by optical photothermal infrared microspectroscopy. Nat Nanotechnol 2022, 17 (1), 76-85.
62. Zangmeister, C. D.; Radney, J. G.; Benkstein, K. D.; Kalanyan, B., Common Single-Use Consumer Plastic Products Release Trillions of Sub-100 nm Nanoparticles per Liter into Water during Normal Use. Environmental Science & Technology 2022, 56 (9), 5448-5455.
63. Zhang, Q.; Xu, E. G.; Li, J.; Chen, Q.; Ma, L.; Zeng, E. Y.; Shi, H., A Review of Microplastics in Table Salt, Drinking Water, and Air: Direct Human Exposure. Environ Sci Technol 2020, 54 (7), 3740-3751.
64. Gambino, I.; Bagordo, F.; Grassi, T.; Panico, A.; De Donno, A., Occurrence of Microplastics in Tap and Bottled Water: Current Knowledge. Int J Environ Res Public Health 2022, 19 (9).
65. Yusuf, A.; Sodiq, A.; Giwa, A.; Eke, J.; Pikuda, O.; Eniola, J. O.; Ajiwokewu, B.; Sambudi, N. S.; Bilad, M. R., Updated review on microplastics in water, their occurrence, detection, measurement, environmental pollution, and the need for regulatory standards. Environ Pollut 2022, 292 (Pt B), 118421.
66. Mason, S. A.; Welch, V. G.; Neratko, J., Synthetic polymer contamination in bottled water. Frontiers in chemistry 2018, 407.
67. Koelmans, A. A.; Mohamed Nor, N. H.; Hermsen, E.; Kooi, M.; Mintenig, S. M.; De France, J., Microplastics in freshwaters and drinking water: Critical review and assessment of data quality. Water Res 2019, 155, 410-422.
68. Ossmann, B. E.; Sarau, G.; Holtmannspotter, H.; Pischetsrieder, M.; Christiansen, S. H.; Dicke, W., Small-sized microplastics and pigmented particles in bottled mineral water. Water Res 2018, 141, 307-316.
69. Oßmann, B. E., Microplastics in drinking water? Present state of knowledge and open questions. Current Opinion in Food Science 2021, 41, 44-51.
70. Huang, Y.; Wong, K. K.; Li, W.; Zhao, H.; Wang, T.; Stanescu, S.; Boult, S.; van Dongen, B.; Mativenga, P.; Li, L., Characteristics of nano-plastics in bottled drinking water. J Hazard Mater 2022, 424 (Pt C), 127404.
71. Rennick, J. J.; Johnston, A. P.; Parton, R. G., Key principles and methods for studying the endocytosis of biological and nanoparticle therapeutics. Nature nanotechnology 2021, 16 (3), 266-276.
72. He, Y.; Park, K., Effects of the microparticle shape on cellular uptake. Molecular pharmaceutics 2016, 13 (7), 2164-2171.
73. Gebel, T.; Foth, H.; Damm, G.; Freyberger, A.; Kramer, P.-J.; Lilienblum, W.; Röhl, C.; Schupp, T.; Weiss, C.; Wollin, K.-M., Manufactured nanomaterials: categorization and approaches to hazard assessment. Archives of toxicology 2014, 88 (12), 2191-2211.
74. Hubbs, A. F.; Mercer, R. R.; Benkovic, S. A.; Harkema, J.; Sriram, K.; Schwegler-Berry, D.; Goravanahally, M. P.; Nurkiewicz, T. R.; Castranova, V.; Sargent, L. M., Nanotoxicology-A pathologist's perspective. Toxicologic pathology 2011, 39 (2), 301-324.
75. Arcadio, C. G. L. A.; Navarro, C. K. P.; Similatan, K. M.; Inocente, S. A. T.; Ancla, S. M. B.; Banda, M. H. T.; Capangpangan, R. Y.; Torres, A. G.; Bacosa, H. P., Microplastics in surface water of Laguna de Bay: First documented evidence on the largest lake in the Philippines. Environmental Science and Pollution Research 2022, 1-10.
76. Mu, J.; Qu, L.; Jin, F.; Zhang, S.; Fang, C.; Ma, X.; Zhang, W.; Huo, C.; Cong, Y.; Wang, J., Abundance and distribution of microplastics in the surface sediments from the northern Bering and Chukchi Seas. Environmental Pollution 2019, 245, 122-130.
77. Schymanski, D.; Goldbeck, C.; Humpf, H.-U.; Fürst, P., Analysis of microplastics in water by micro-Raman spectroscopy: release of plastic particles from different packaging into mineral water. Water research 2018, 129, 154-162.
78. Kankanige, D.; Babel, S., Smaller-sized micro-plastics (MPs) contamination in single-use PET-bottled water in Thailand. Science of the total environment 2020, 717, 137232.
79. Cox, K. D.; Covernton, G. A.; Davies, H. L.; Dower, J. F.; Juanes, F.; Dudas, S. E., Human consumption of microplastics. Environmental science & technology 2019, 53 (12), 7068-7074.
80. Fournier, S. B.; D′Errico, J. N.; Adler, D. S.; Kollontzi, S.; Goedken, M. J.; Fabris, L.; Yurkow, E. J.; Stapleton, P. A., Nanopolystyrene translocation and fetal deposition after acute lung exposure during late-stage pregnancy. Particle and Fibre Toxicology 2020, 17, 1-11.
81. Banerjee, A.; Shelver, W. L., Micro- and nanoplastic induced cellular toxicity in mammals: A review. Science of the Total Environment 2021, 755, 142518.
82. Stanton, T.; Johnson, M.; Nathanail, P.; Gomes, R. L.; Needham, T.; Burson, A., Exploring the efficacy of Nile red in microplastic quantification: a containing approach. Environmental Science & Technology Letters 2019, 6 (10), 606-611.
83. Bai, Y.; Yin, J.; Cheng, J.-X., Bond-selective imaging by optically sensing the mid-infrared photothermal effect. Science advances 2021, 7 (20), eabg1559.
84. Dazzi, A.; Prater, C. B., AFM-IR: Technology and applications in nanoscale infrared spectroscopy and chemical imaging. Chemical reviews 2017, 117 (7), 5146-5173.
85. Weisser, J.; Beer, I.; Hufnagl, B.; Hofmann, T.; Lohninger, H.; Ivleva, N. P.; Glas, K., From the well to the bottle: identifying sources of microplastics in mineral water. Water 2021, 13 (6), 841.
86. Organization, W. H., Microplastics in drinking-water. 2019.
87 Geise, G. M., Why polyamide reverse-osmosis membranes work so well. Science 2021, 371 (6524), 31-32.
88. Vagliasindi, F. G.; Belgiorno, V.; Napoli, R. M., Water treatment in remote and rural areas: A conceptual screening protocol for appropriate pou/poe technologies. In Environmental Engineering and Renewable Energy, Elsevier: 1998; pp 329-336.
89. Krug, H. F.; Wick, P., Nanotoxicology: an interdisciplinary challenge. Angewandte Chemie International Edition 2011, 50 (6), 1260-1278.
90. Domingues, C.; Santos, A.; Alvarez-Lorenzo, C.; Concheiro, A.; Jarak, I.; Veiga, F.; Barbosa, I.; Dourado, M.; Figueiras, A., Where is nano today and where is it headed? A review of nanomedicine and the dilemma of nanotoxicology. ACS nano 2022, 16 (7), 9994-10041.

1. A method is provided of determining the presence of, and polymer identity of, polymer nano-particles in a sample, the method comprising:
(a) exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
(b) identifying one or more regions of interest (ROI) corresponding to a nano-particle in the hyperspectral images or SRS images, and quantifying the intensity of the SRS signal across a predetermined range of wavelengths in said ROI across the hyperspectral images to obtain a detected SRS spectrum in the ROI; and
(c) for each of at least one polymer identity, calculating a respective spectral matching coefficient (SMC_{SRS}) based on the detected SRS spectrum obtained from the ROI and predetermined real or simulated plastic nano-particle standard SRS spectrum data corresponding to the polymer identity; and
(d) for each of the at least one polymer identity determining whether the respective SMC_{SRS} is below a threshold condition corresponding to the polymer identity;
wherein if the respective SMC_{SRS} is above the threshold condition, the particle does not correspond to the polymer identity and wherein when the respective SMC_{SRS} is below the threshold condition the particle does correspond to the polymer identity.

2. A method is provided of determining the presence of, and polymer identity of, polymer nano-particles in a sample, the method comprising:
(a) exposing at least a portion of the sample to a pump beam and at least one Stokes beam so as to effect stimulated Raman scattering (SRS) on the portion of the sample and collecting SRS signal(s) so as to obtain a plurality of hyperspectral images or obtaining, from a multiphoton laser scanning microscope configured to perform hyperspectral stimulated Raman scattering microscopy, a plurality of SRS images of the sample;
(b) identifying one or more regions of interest (ROI) corresponding to a nano-particle in the hyperspectral images, and quantifying the intensity of the SRS signal across a predetermined range of wavelengths in said ROI across the hyperspectral images to obtain a detected SRS spectrum in the ROI; and
(c) for each of at least one polymer identity, calculating a respective spectral matching coefficient (SMC_{SRS}) based on the detected SRS spectrum obtained from the ROI and predetermined real standard SRS spectrum data corresponding to the polymer identity; and
(d) for each of the at least one polymer identity determining whether the respective SMC_{SRS} is below a threshold condition corresponding to the polymer identity;
wherein if the respective SMC_{SRS} is above the threshold condition, the particle does not correspond to the polymer identity and wherein when the respective SMC_{SRS} is below the threshold condition the particle does correspond to the polymer identity.

3. The method of claim 1, wherein the detected SRS spectrum comprises detected signals within the predetermined range of wavelengths.

4. The method of claim 2, wherein the detected SRS spectrum comprises detected signals within the predetermined range of wavelengths.

5. A method of generating a simulated standard SRS spectrum for a microparticle of a compound in a sample comprising:
(a) exposing at least a portion of sample to a pump laser light/narrowband Stokes laser so as to effect hyperspectral stimulated Raman spectroscopy (SRS) on a portion of the sample and collecting any stimulated Raman signal(s) so as to obtain a plurality of hyperspectral stacked images;
(b) identifying one or more regions of interest (ROI) in the hyperspectral stacked images, the ROI containing a microparticle of a compound, and quantifying the intensity of the SRS signal in said ROI across the hyperspectral stacked images to obtain an SRS spectrum in the ROI, and
(c) calculating a spectral matching coefficient (SMC_{SRS}) therefrom, wherein SMC_{SRS} is calculated as follows:
$${SMC}_{SRS} = {min}_{α , 0 \leq β < 1} {‖ x - ( α s + β b ) ‖}_{2} ,$$
wherein c is the obtained SRS spectrum x originating from scaling with an obtained SRS spectrum intensity factor α, wherein s is the normalized bulk standard spectrum, and
wherein βb is a background contribution for the system in which the method is being performed at the imaging condition (0≤β<1);
(d) plotting ln(SMC_{SRS}) against SRS intensity a; and
(e) calculating therefrom a threshold condition so as to determine a simulated standard SRS spectrum for said microparticle compound.

6. The method of claim 5, wherein the microparticle comprises a plastic.

7. The method of claim 5, wherein the simulated plastic nano-particle standard SRS spectrum is obtained by conducting simulation based on a known plastic nano-particle standard SRS spectrum with one or more parameters.

8. The method of claim 5, wherein one or more parameters comprise noise on SRS intensity.

9. The method of claim 5, wherein one or more parameters comprise frequency uncertainty.

10. The method of claim 5, wherein frequency uncertainty is instrumental frequency fluctuation.

11. The method of claim 5, wherein the instrumental frequency fluctuation is a gaussian distribution.

12. The method of claim 5, wherein the gaussian distribution has a full width at half maximum (FWHM) of 10 cm⁻¹.

13. The method of claim 5, wherein the plastic comprises polyamide 66 (PA), polypropylene (PP), polyethylene (PE), polymethyl methacrylate (PMMA), polyvinyl chloride (PVC), polystyrene (PS), and polyethylene terephthalate (PET).

14. The method of claim 5, wherein the known plastic nano-particle standard SRS spectrum is nano-particle standard SRS spectrum of PS.

15. The method of claim 1, wherein the method further comprises extracting morphological information from the ROI of the hyperspectral stacked images so as to identify, and optionally quantify, one or more morphological parameters of the particle in the ROI.

16. The method of claim 1, wherein the calculated SMC_{SRS} is compared to SMC_{SRS} of a library of predetermined real or simulated plastic nano-particle standards SRS spectrum data or wherein the predetermined real or simulated plastic nano-particle standard SRS spectrum data is obtained from a library of plastic nano-particle standards.

17. The method of claim 1, wherein when the calculated SMC_{SRS} is below the threshold condition corresponding to more than one polymer identity, determining the corresponding polymer identity based on the lowest SMC_{SRS}.

18. The method of claim 1, wherein the at least one Stokes beam is a narrowband Stokes laser pulsed as a picosecond pulse or in the form of spectral focusing of chirped femtosecond pulse.

19. The method of claim 1, wherein the SMC_{SRS} is calculated from:
$${SMC}_{SRS} = {min}_{α , 0 \leq β < 1} {‖ x - ( α s + β b ) ‖}_{2} ,$$
wherein c is the detected particle spectrum,
wherein a is a scaling factor corresponding to the intensity of the obtained SRS spectrum, wherein s is normalized bulk standard spectrum, and
wherein b is a background contribution of the system in which the method is being performed at the imaging condition with 0≤β<1.

20. The method of claim 1, wherein SMC_{SRS} is based on the difference between the fitted spectrum (αs+βb) and the detected particle spectrum and/or wherein, the background contribution is obtained by cropping a particle-free area in the same imaging stack as the system in which the method is being performed.
